(19) United States
(12) Patent Application Publication
(10) Pub. No.: US 2006/0243701 A1
(43) Pub. Date: Nov. 2, 2006

(54) LIQUID DISCHARGE HEAD AND LIQUID DISCHARGE HEAD MANUFACTURING METHOD, CHIP ELEMENT, AND PRINTING APPARATUS

(76) Inventors: Shogo Ono, Kanagawa (JP); Manabu Tomita, Kanagawa (JP); Koichi Igarashi, Kanagawa (JP); Takaaki Miyamoto, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/379,071

(22) Filed: Apr. 18, 2006

(30) Foreign Application Priority Data
Apr. 19, 2005 (JP) P2005-120437
May 12, 2005 (JP) P2005-140445
May 30, 2005 (JP) P2005-157388

(51) Int. Cl. G01D 15/00; B41J 2/15

(52) U.S. Cl. 216/27; 347/40

(57) ABSTRACT

A liquid discharge head includes: a plurality of energy generating elements arranged in one direction on a substrate; a coating layer formed on the substrate and having formed therein a plurality of discharge ports opposed to the energy generating elements; and an individual passage formed on the substrate and extending in a direction orthogonal to a direction in which the energy generating elements are arranged. The coating layer on the individual passage has an opening formed therein.

### CROSS REFERENCES TO RELATED APPLICATIONS

The present invention contains subject matters related to Japanese Patent Application JP 2005-120437 filed in the Japanese Patent Office on Apr. 19, 2005, Japanese Patent Application JP 2005-157388 filed in the Japanese Patent Office on May 30, 2005, and Japanese Patent Application JP 2005-140445 filed in the Japanese Patent Office on May 12, 2005, the entire contents of which are incorporated herein by reference.

### BACKGROUND OF THE INVENTION

1. Field of the Invention

The present invention relates to a liquid discharge head, which is used as, for example, a printer head or the like of an ink jet printer, and a liquid discharge head manufacturing method, a chip element used for the liquid discharge head, and a printing apparatus.

2. Description of the Related Art

In the related art, a thermal printer head is known as an example of a liquid discharge head. The printer head includes, on a substrate, a plurality of heater elements arranged in one direction, a coating layer in which a plurality of discharge ports opposed to the respective heater elements are arranged, and individual passages for supplying ink to the respective heater elements. In the printer head, ink is discharged from the discharge ports by driving the heater elements, thereby performing printing.

FIG. 12 is a side sectional view showing such a printer head 30 according to the related art.

As shown in FIG. 12, the print head 30 according to the related art includes an ink supply member 41 and a chip 31 bonded onto the ink supply member 41. The chip 31 includes heater elements 33 arranged on a semiconductor substrate 32, with a coating layer 35 being provided so that discharge ports 34 are located above the heater elements 33. Further, each individual passage 36 for ink is formed in the region above the heater elements 33. A though-hole 36 communicating with the individual passage 36 is formed in the semiconductor substrate 32.

On the other hand, the ink supply member 41 is formed by machining using aluminum, stainless, resin, or the like. Further, in FIG. 12, the ink supply member 41 has an ink supply port 42 provided on the lower surface side thereof. A common passage 43 is formed so as to communicate with the ink supply port 42 and penetrate the base of the ink supply member 41. Ink is thus supplied from an external ink tank or the like (not shown) into the common passage 43 by way of the ink supply port 42. The ink passes through the through-hole 37 of the chip 31 to enter the individual passage 36, and then fills the region above the heater elements 33.

When the heater elements 33 are driven in this state and the ink is rapidly heated, bubbles are generated on the heater elements 33. Due to a pressure change occurring at the time when the bubbles are generated, the ink on the heater elements 33 are discharged from the discharge ports 34 in the form of ink droplets. Further, the discharged ink droplets impact on a printing sheet or the like, thus forming pixels.

Incidentally, the chip 31 of the printer head 30 according to the related art shown in FIG. 12 is manufactured as follows.

That is, first, the heater elements 33 are formed on a substrate (semiconductor substrate 32) made of silicon or the like using a semiconductor manufacturing technique. Then, a sacrificial layer corresponding to the individual passage 36 is formed above the heater elements 33 by patterning a soluble resin, for example, a photosensitive resin such as a photoresist through photolithography. Further, the coating layer 35 that becomes a discrete structure is formed by, for example, coating resin onto the sacrificial layer by spin coating or the like.

Subsequently, the discharge ports 34 are formed in the coating layer 35 by dry etching or, when the coating layer 35 is made of photosensitive resin, for example, by photolithography. Thereafter, a through-hole 37 is bored by wet etching or the like from the back surface of the semiconductor substrate 32, and a dissolving liquid (when the sacrificial layer is made of photosensitive resin, the developing solution thereof) for the sacrificial layer is poured in from the through-hole 37, thereby eluting and removing the sacrificial layer. The chip 31 having the individual passage 36 formed on the semiconductor substrate 32 is thus manufactured (see, for example, Japanese Patent No. 3343875).

### SUMMARY OF THE INVENTION

According to the above-mentioned technique described in Japanese Patent No. 3343875, when eluting the sacrificial layer to form the individual passage 36, the through-hole 37 is bored from the back surface of the semiconductor substrate 32. In this regard, the step of boring the through-hole 37 in the semiconductor substrate 32 is generally performed by one or both of anisotropic wet etching and dry etching.

However, the use of anisotropic wet etching involves the following problems.

That is, first, due to the extremely slow etching rate (on the order of 0.5 to 1.0 μm/min), a minimum of about 10 hours is required to bore the through-hole 37 in the semiconductor substrate 32 having a thickness of, for example, 600 μm, which means that too much manufacturing time is required.

Second, when boring the through-hole 37, it is necessary to form a member serving as an etching mask in the region other than the through-hole 37, which adds complexity to the process.

Third, when, for example, an aluminum terminal (PAD) or the like is present on the surface of the semiconductor substrate 32, the aluminum terminal is eroded by the etching liquid as it spreads onto the surface of the semiconductor substrate 32. Accordingly, it is necessary to make contrivances to prevent the etching liquid from spreading onto the surface or provide a protective layer so that no problem occurs even when the etching liquid does spread onto the surface.

On the other hand, the use of drying etching also involves the following problems.

That is, first, the etching rate is even slower than that in the case of anisotropic wet etching.

Second, like the second problem associated with the use of anisotropic wet etching mentioned above, it is necessary to form an etching mask.

As described above, anisotropic wet etching or dry etching is employed when boring the through-hole 37 in the back surface of the semiconductor substrate 32 to enable elution of the sacrificial layer. As a result, the manufacturing process becomes complicated and the manufacturing time also increases. This results in poor yield and high cost of the printer head 30.

It is desirable to manufacture a liquid discharge head inexpensively and with good yield by making it possible to elute the sacrificial layer without boring a through-hole in the semiconductor substrate.

According to an embodiment of the present invention, there is provided a liquid discharge head including: a plurality of energy generating elements arranged in one direction on a substrate; a coating layer formed on the substrate and having formed therein a plurality of discharge ports opposed to the energy generating elements; and an individual passage formed on the substrate and extending in a direction orthogonal to a direction in which the energy generating elements are arranged, the liquid discharge head being adapted to discharge a liquid, which is supplied to the individual passage, from each of the discharge ports by the energy generating elements, wherein the coating layer on the individual passage has an opening formed therein.

In the above-mentioned embodiment of the present invention, in addition to the discharge ports, the opening is formed in the coating layer formed on the substrate. Accordingly, when dissolving the sacrificial layer by the dissolving liquid, the sacrificial layer can be eluted from the discharge ports and the opening without boring a through-hole in the substrate. That is, each individual passage of the liquid discharge head is formed by eluting the sacrificial layer from the discharge ports and the opening.

As described above, according to the above-mentioned embodiment of the present invention, the opening is formed in the coating layer, and the individual passage is formed by eluting the sacrificial layer from the discharge ports and the opening. A liquid discharge head with no through-hole formed in the substrate can be thus obtained. Further, irrespective of the elution of the sacrificial layer, the opening above the individual passage also serves as the opening for removing bubbles that are present in the liquid in the individual passage, thereby making it possible to obtain a liquid discharge head with stable liquid discharge characteristics. Note that when there is a fear of liquid leakage from the opening, the opening is closed, thereby making it possible to obtain a liquid discharge head that can reliably prevent liquid leakage.

Further, according to an embodiment of the present invention, there is provided a liquid discharge head manufacturing method, including: a first step of forming a sacrificial layer on a substrate, on which a plurality of energy generating elements for discharging a liquid are arranged in one direction, from a soluble resin; a second step of forming a coating layer on the sacrificial layer; a third step of forming in the coating layer a plurality of discharge ports opposed to the energy generating elements, the third step being performed simultaneously with or after the second step; a fourth step of forming an individual passage by eluting the sacrificial layer, the individual passage extending in a direction orthogonal to a direction in which the energy generating elements are arranged; and an opening forming step of forming an opening in the coating layer on the individual passage, the opening forming step being performed simultaneously with or before or after the third step.

In the above-mentioned embodiment of the present invention, the liquid discharge head is manufactured through the process including the first to fourth steps. Further, the manufacturing process for the liquid discharge head includes the opening forming step. Accordingly, when dissolving the sacrificial layer by the dissolving liquid to form the individual passage, the sacrificial layer can be eluted from the discharge ports and the opening without boring a through-hole in the substrate.

The step of forming a through-hole in the substrate thus becomes unnecessary, thereby making it possible to manufacture a liquid discharge head inexpensively and with good yield.

According to an embodiment of the present invention, there is provided a liquid discharge head including: a plurality of energy generating elements arranged in one direction on a substrate; an individual passage formed on the substrate and extending in a direction orthogonal to a direction in which the energy generating elements are arranged; and a coating layer covering the individual passage and having formed therein a plurality of discharge ports opposed to the energy generating elements, the liquid discharge head being adapted to discharge a liquid, which is supplied to the individual passage, from each of the discharge ports by the energy generating elements, wherein the coating layer has a recessed portion formed in a portion of the coating layer on a side opposite to the discharge ports across the individual passage, the recessed portion being recessed toward the individual passage.

In the above-mentioned embodiment of the present invention, the recessed portion recessed toward the individual passage is formed in the coating layer. Accordingly, when cutting the substrate using a dicer, the water flow can be released from the recessed portion of the coating layer. Thus, no defects such as cracking or peeling occurs in the canopy portion of the coating layer. Therefore, a liquid discharge head that can reliably prevent liquid leakage can be obtained. Further, the liquid head obtained has no through-hole formed in the substrate.

According to an embodiment of the present invention, there is provided a liquid discharge head manufacturing method, including: a first step of forming a sacrificial layer on a substrate, on which a plurality of energy generating elements for discharging a liquid are arranged in one direction, from a soluble resin; a second step of forming a coating layer on the sacrificial layer; a third step of forming in the coating layer a plurality of discharge ports opposed to the energy generating elements, the third step being performed simultaneously with or after the second step; a fourth step of forming an individual passage by eluting the sacrificial layer, the individual passage extending in a direction orthogonal to a direction in which the energy generating elements are arranged; an opening forming step of forming an opening in the coating layer so that the coating layer has a recessed portion, which is recessed toward the individual passage, formed in a portion of the coating layer on a side opposite to the discharge ports across the individual passage, the opening forming step being performed simultaneously with or before or after the third step; and a cutting step of cutting the substrate inside the opening.

In the above-mentioned embodiment of the present invention, the liquid discharge head is manufactured through the process including the first to fourth steps. Further, the manufacturing process for the liquid discharge head includes the opening forming step of forming an opening in the coating layer so that the coating layer has a recessed portion, which is recessed toward the individual passage, formed in a portion of the coating layer on the side opposite to the discharge ports across the individual passage. Accordingly, when dissolving the sacrificial layer by the dissolving liquid to form the individual passage, the sacrificial layer can be eluted from the discharge ports and the opening without boring a through-hole in the substrate. Further, the manufacturing process for the liquid discharge head includes the cutting step of cutting the substrate inside the opening. In this regard, since the coating layer has the recessed portion recessed toward the individual passage, the substrate can be cut without causing cracking, peeling, or the like in the canopy portion of the coating layer. Thus, it is possible to manufacture a liquid discharge head inexpensively and with good yield.

Further, according to an embodiment of the present invention, there is adopted a construction in which a driver element region, a heater element region, and a control circuit region are arranged in this order from the side surface end portion of a semiconductor chip which is in contact with the common passage for the liquid, toward the side where an ink chamber is arranged.

In the case of the chip element according to the above-mentioned embodiment of the present invention, it is not necessary to provide the semiconductor substrate with a through-hole for connecting to the common passage. Accordingly, the manufacturing time for the chip element can be significantly shortened by an amount corresponding to the time that is otherwise required for machining such a through-hole. Further, in the case of the chip element as described above, since the driver element region is located on the side end portion side of the chip element in contact with the common passage, the upper surface portion thereof can be used as the bonding region for the sealing member that seals the opening of the common passage. Accordingly, the region for bonding the sealing member (overlap width portion) can be made unnecessary, thereby achieving a reduction in the surface area of the chip element. A reduction in manufacturing cost can be thus achieved.

### BRIEF DESCRIPTION OF THE DRAWINGS

FIG. 1 is a side sectional view showing a printer head according to a first embodiment of the present invention;

FIG. 2 is a plan sectional view showing the printer head according to the first embodiment of the present invention;

FIGS. 3A and 3B are side sectional views sequentially illustrating the intermediate steps performed in a method of manufacturing the printer head according to the first embodiment.

FIGS. 4A and 4B are side sectional views illustrating steps subsequent to the steps shown in FIGS. 3A and 3B;

FIGS. 5A and 5B are side sectional views illustrating steps subsequent to the steps shown in FIGS. 4A and 4B;

FIG. 6 is a side sectional view illustrating a step subsequent to the steps shown in FIGS. 5A and 5B;

FIG. 7 is a side sectional view showing a printer head according to a second embodiment of the present invention;

FIG. 8 is a side sectional view showing a printer head according to a third embodiment of the present invention;

FIG. 9 is a side sectional view showing a printer head according to EXAMPLE 1 of the present invention;

FIG. 10 is a side sectional view showing a printer head according to EXAMPLE 2 of the present invention;

FIG. 11 is a side sectional view showing a printer head according to EXAMPLE 3 of the present invention;

FIG. 12 is a side sectional view showing a printer head according to the related art;

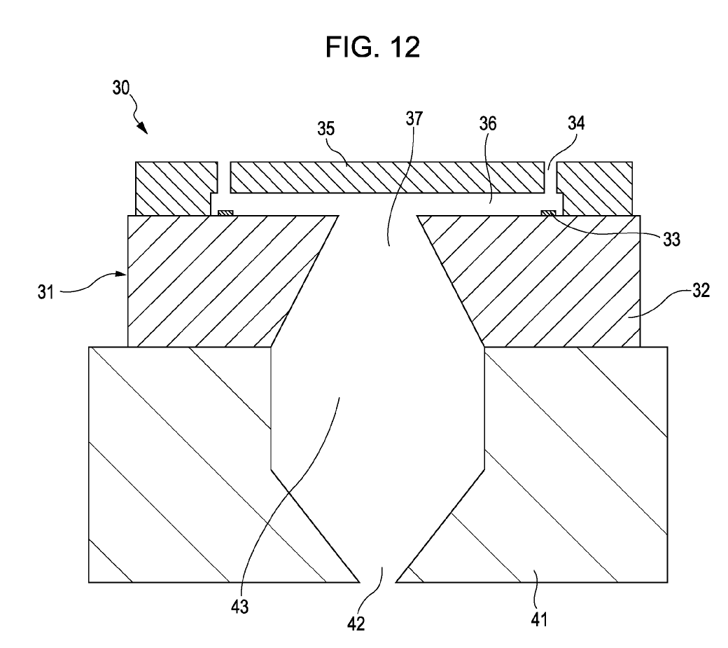

FIGS. 13A and 13B are side sectional views sequentially illustrating the intermediate steps performed in a method of manufacturing a printer head according to a fourth embodiment of the present invention;

FIGS. 14A and 14B are side sectional views illustrating steps subsequent to the steps shown in FIGS. 13A and 13B;

FIG. 15 is a plan view showing a state in which the steps up to those shown in FIGS. 14A and 14B have been finished;

FIGS. 16A and 16B are a perspective view and a side sectional view, respectively, illustrating a step subsequent to the steps shown in FIGS. 14A and 14B;

FIGS. 17A and 17B are a plan view and a side sectional view, respectively, showing the step shown in FIGS. 16A and 16B.

FIG. 18 is a side sectional view illustrating a step subsequent to the step shown in FIGS. 16A and 16B;

FIG. 19 is a is a side sectional view showing the printer head according to the fourth embodiment;

FIGS. 20A and 20B are a plan view and a sectional view, respectively, showing the intermediate steps performed in a method of manufacturing a printer head according to a fifth embodiment of the present invention;

FIG. 21 is a side sectional view showing a printer head according to a sixth embodiment of the present invention;

FIG. 22 is a plan view showing a state in which steps up to an intermediate step have been finished in a method of manufacturing a printer head according to a sixth embodiment of the present invention;

FIG. 23 is a side sectional view showing the printer head according to the sixth embodiment of the present invention;

FIGS. 24A and 24B are a side sectional view and a perspective view, respectively, showing a part of an improved chip manufacturing method;

FIGS. 25A and 25B are a plan view and a side sectional view, respectively, showing defects occurring in the improved chip manufacturing method;

FIG. 26 is a view showing an example of a printer head manufacturing process (first to fourth steps);

FIG. 27 is a view showing an example of a printer head manufacturing process (fifth step);

FIG. 28 is a view showing an example of a printer head manufacturing process (sixth step);

FIG. 29 is a view showing an example of a printer head manufacturing process (seventh step);

FIG. 30 is a view showing an example of a printer head manufacturing process (eighth step);

FIG. 31 is a view showing an example of the circuit pattern of a chip element;

FIG. 32 is a view showing an example of the sectional structure of a printer head;

FIG. 33 is a view showing an example of the planer structure of a printer head;

FIG. 34 a view showing another example of the circuit pattern of a chip element;

FIG. 35 is a view showing an arrangement example of a one-layer type wiring pattern;

FIG. 36 is a view showing an arrangement example of a one-layer type wiring pattern;

FIG. 37 is an equivalent circuit diagram of a one-layer type wiring pattern;

FIG. 38 is a view showing an arrangement example of a two-layer type wiring pattern;

FIG. 39 is an equivalent circuit diagram of a two-layer type wiring pattern;

FIG. 40 is a view showing an example of the wiring pattern of the second layer;

FIG. 41 is a view showing an example of the wiring pattern of the first layer;

FIG. 42 is a view showing an example of a control wiring pattern;

FIG. 43 is a view showing the wiring patterns shown in FIGS. 40 to 42 in an overlapped manner;

FIG. 44 is a view showing an arrangement example of heater elements adapted for deflected discharge;

FIG. 45 is a view showing an example of a wiring pattern for deflected discharge; and

FIGS. 46A to 46C are views showing the relationship between the applied energy and the direction of deflected discharge.

### DESCRIPTION OF THE PREFERRED EMBODIMENTS

Embodiments of the present invention will now be described with reference to the drawings. Note that in the following embodiments of the present description, a liquid discharge head and a liquid discharge head manufacturing method according to the present invention will be described as being applied to a thermal type inkjet printer (hereinafter, simply referred to as the “printer head”) for discharging ink as a liquid, and a manufacturing method for the printer head.

### First Embodiment

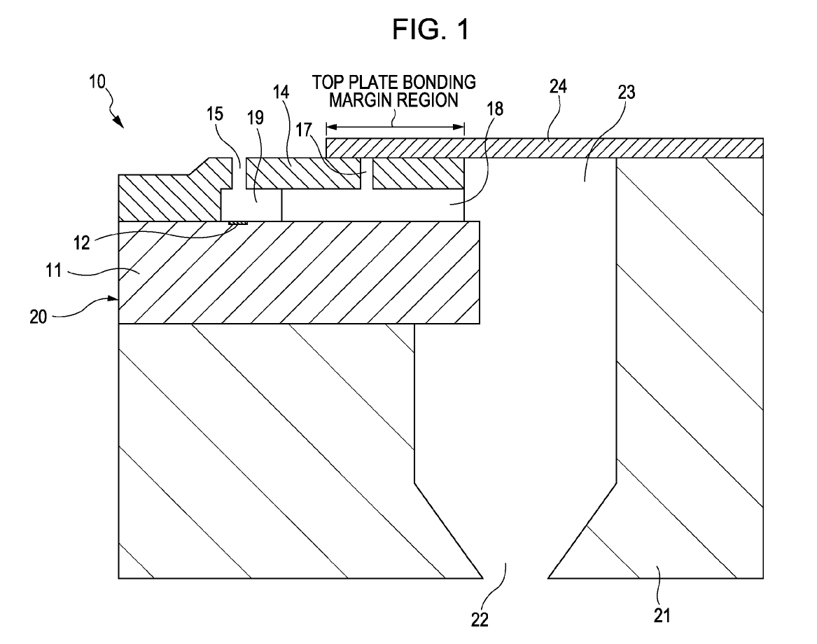

FIG. 1 is a side sectional view showing a printer head 10 according to a first embodiment of the present invention.

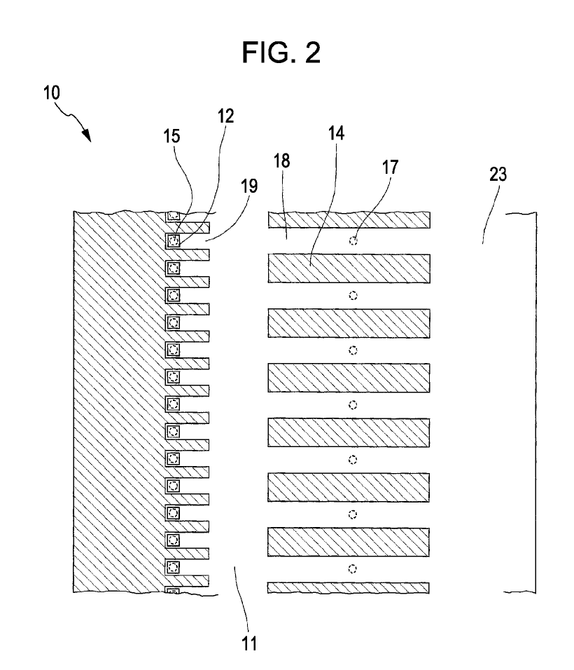

Further, FIG. 2 is a plan sectional view showing the printer head 10 according to the first embodiment.

As shown in FIG. 1, in the printer head 10 according to the first embodiment, one chip 20 is bonded to an ink supply member 21 (corresponding to the “liquid supply member” as referred to as in the present invention), with a top plate 24 being affixed in place so as to straddle the upper surface of the chip 20 and the upper surface of the ink supply member 21.

As shown in FIGS. 1 and 2, the chip 20 includes, on a semiconductor substrate 11 (corresponding to the “substrate” as referred to as in the present invention), a plurality of heater elements 12 (corresponding to the “energy generating elements” as referred to as in the present invention) arranged in one direction, a coating layer 14 provided with a plurality of discharge ports 15 opposed to the respective heater elements 12, and individual passages 18 extending in the direction orthogonal to the alignment direction of the heater elements 12. Further, a region above each heater element 12 which communicates with each individual passage 18 serves as a liquid chamber 19. On the other hand, as shown in FIG. 1, an ink supply port 22 and a common passage 23 are formed in the ink supply member 21. The common passage 23 communicates with the individual passages 18.

Further, the top plate 24 seals the portion of the ink supply member 21 penetrated for forming the common passage 23, and covers an opening 17 above the individual passage 18 formed in the coating layer 14. Accordingly, when ink enters the ink supply member 21 from the ink supply port 22, the ink passes through the common passage 23 and enters the individual passage 18 and liquid chamber 19 of the chip 20. When the heater elements 12 are heated in this state, bubbles are generated in the ink on the heater elements 12. Due to a pressure change at the time of this bubble generation (expansion and contraction of the bubbles), a part of the ink is discharged from each discharge port 15 in the form of an ink droplet.

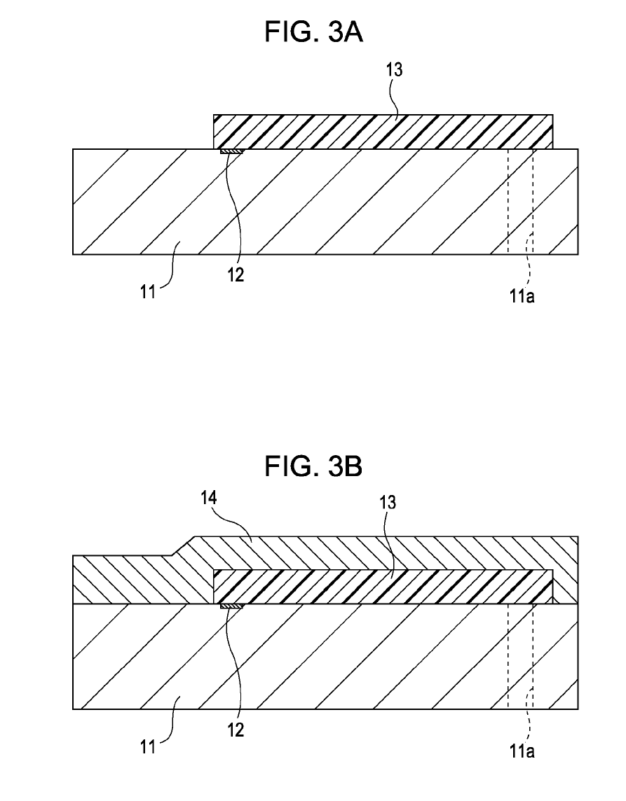

FIGS. 3A to 6 are side sectional views sequentially illustrating the intermediate steps performed in a method of manufacturing the printer head 10 according to the first embodiment shown in FIGS. 1 and 2.

First, FIGS. 3A and 3B are views showing a first step of forming a sacrificial layer 13 on the semiconductor substrate 11, and a second step of forming the coating layer 14 on the sacrificial layer 13, respectively. That is, as shown in FIG. 3A, the heater elements 12 are formed on the semiconductor substrate 11 made of silicon, glass, ceramic, or the like by, for example, a microprocessing technique for manufacturing a semiconductor or electronic device. Here, the heater elements 12 are arranged continuously in one direction at a predetermined pitch with respect to the direction perpendicular to the plane of FIG. 3A. In the case of the printer head 10 having a resolution of 600 DPI, for example, the pitch between the heater elements is 42.3 μm.

Further, a sacrificial layer 13 is formed in the region serving as the individual passage and including at least the region serving as the ink chamber above the heater element 12 (first step). The sacrificial layer 13 is formed by applying soluble resin, for example, photosensitive resin such as a photoresist onto the semiconductor substrate 11 and the heater element 12 by spin coating or the like in order to form the ink chamber and the individual passage, then forming the patterns of the ink chamber and individual passage by photolithography.

Next, as shown in FIG. 3B, for example, a photosensitive resist is applied onto the sacrificial layer 13 by spin coating or the like, thereby forming the coating layer 14 in the region including the region where the sacrificial layer 13 is formed (second step). The coating layer 14 is a layer that serves as a commonly used nozzle sheet or barrier layer.

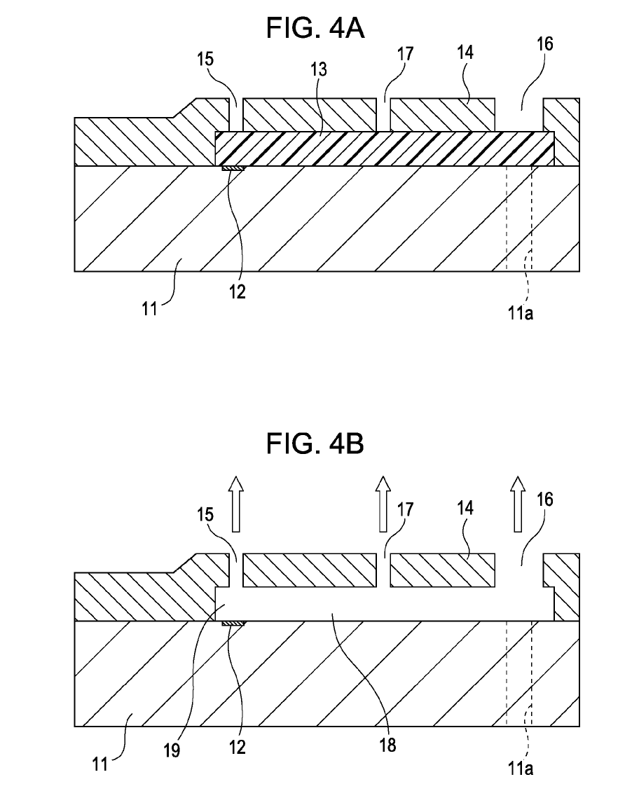

FIGS. 4A and 4B are respectively a view showing a third step of forming the discharge port 15 in the coating layer 14 formed in the second step shown in FIG. 3B, a cutting opening forming step of forming a cutting opening 16, and an opening forming step of forming an opening 17, and a view showing a fourth step of eluting the sacrificial layer 13 to thereby form the individual passage 18. While the discharge port 15, the cutting opening 16, and the opening 17 are formed simultaneously in the first embodiment, they may be formed separately during the process prior to the fourth step.

As shown in FIG. 4A, the discharge port 15 is formed at the portion of the coating layer 14 located directly above each heater element 12 (third step). At this time, when, for example, the coating layer 14 is made of photosensitive resin, the discharge port 15 is formed through patterning by photolithography so as to reach the sacrificial layer 13, that is, so as to penetrate the coating layer 14.

Further, at the same time and in a similar manner, the cutting opening 16 for dicing is formed above a dicing line 11a along which the semiconductor substrate 11 is to be cut (cutting opening forming step). That is, the portion of the coating layer 14 above the dicing line 11a is removed to expose the sacrificial layer 13 located below the coating layer 14, thereby forming the cutting opening 16. Furthermore, at the same time and in a similar manner, the opening for eluting the sacrificial layer 13 to the outside is formed (opening forming step). Note that for the simultaneous formation of the discharge port 15, cutting opening 16, and opening 17, a photomask allowing simultaneous formation of these portions may be used.

Here, the opening 17 is formed at the middle between the discharge port 15 and the cutting opening 16 so that at the time of eluting the sacrificial layer 13 in the next step (fourth step), the sacrificial layer 13 is efficiently eluted from three locations including the discharge port 15 and the cutting opening 16. That is, the time required for the elution of the sacrificial layer 13 is reduced by making the amounts of elution of the sacrificial layer 13 from the discharge port 15, cutting opening 16, and opening 17 substantially uniform.

A more detailed description will be given in this regard. When a long time is required for eluting the sacrificial layer 13, the coating layer 14 is eroded by the dissolving liquid for the sacrificial layer 13, causing material defects such as loss of shape or peeling due to swelling. Accordingly, it is preferable that the sacrificial layer 13 be eluted quickly. In view of this, the opening 17 is formed to serve as the opening for eluting the sacrificial layer 13, and further, the opening 17 is formed at the middle between the discharge port 15 and the cutting opening 16, thereby making it possible to elute the sacrificial layer 13 in the shortest possible time.

Further, a large opening 17 is preferably formed in the surface from which the sacrificial layer 13 is eluted. The shape of the opening 17 may be rectangular, circular, or the like. However, when the opening 17 is formed to have the same size and shape as those of the discharge port 15, only the sampling inspection corresponding to the discharge port 15 suffices at the time of inspecting the finished shape, and inspection on the opening 17 can be omitted. Therefore, for simplification of the inspection process, the size and shape of the opening 17 are the same as those of the discharge 16 in the first embodiment.

Note that in the first embodiment, the opening 17 is closed by the top plate in the sealing step performed later in order to prevent leakage of ink from the opening 17. Accordingly, the opening 17 is provided at a position inside the region of the bonding margin for the top plate (top plate bonding margin region). In this case, when the size of the opening 17 formed is large, this causes a corresponding decrease in the bonding surface area between the coating layer 14 and the top plate. However, since the opening 17 is formed to be substantially the same in size as the discharge opening 15 in the first embodiment, a sufficiently large bonding surface area can be secured.

Next, the semiconductor substrate 11, the sacrificial layer 13, and the coating layer 14 are immersed in a liquid vessel filled with a dissolving liquid for dissolving the sacrificial layer 13. Then, as indicated by the arrows in FIG. 4B, the sacrificial layer 13 is eluted from each of the discharge port 15, cutting opening 16, and opening 17, thereby forming the individual passage 18 extending in the direction (direction parallel to the plane of FIG. 4B) orthogonal to the direction of the arrangement (direction perpendicular to the plane of FIG. 4B) of the heater elements 12, with the coating layer 14 serving as the passage wall thereof (fourth step). When the sacrificial layer 13 is a photoresist, a developing solution thereof is used as the dissolving liquid.

When the semiconductor substrate 11, the sacrificial layer 13, and the coating layer 14 are immersed in the dissolving liquid as described above, the sacrificial layer 13 is dissolved by the dissolving liquid and fluidized so as to be eluted to the outside of the coating layer 14 from the discharge port 15, the cutting opening 16, and the coating layer 14 as shown in FIG. 4B. On the other hand, the semiconductor substrate 11 and the coating layer 14 undergo no change in shape before and after the immersion in the dissolving liquid. Accordingly, the portion where the sacrificial layer 13 has been present becomes a void, which in turn becomes the individual passage 18 and the liquid chamber 19. Thus, after the elution of the sacrificial layer 13, the coating layer 14 forms a discrete structure, and the discharge port 15 formed in the coating layer 14 communicates with the individual passage 18. Further, the heater element 12 becomes present within the liquid chamber 19.

As a comparative example, in the case where the opening 17 was not formed, and the sacrificial layer 13 was eluted only from the discharge port 15 and the cutting opening 16, about twice more time was required for completing the elution. That is, in the case of this embodiment, the elution of the sacrificial layer 13 can be performed in about half the time of that required in the comparative example. Therefore, a remarkable reduction in elution time can be achieved by forming the opening 17 for eluting the sacrificial layer 13. Further, there is no fear of the coating layer 14 being eroded by the dissolving liquid for the sacrificial layer 13.

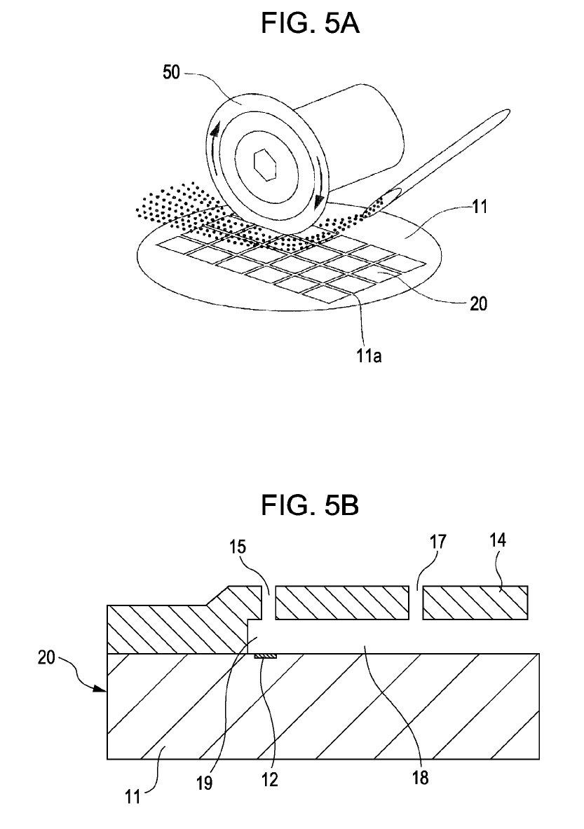

FIGS. 5A and 5B show a cutting step of cutting the semiconductor substrate 11 (FIG. 5A) into single individual chips 20 (FIG. 5B).

In the cutting step, as shown in FIG. 5A, the semiconductor substrate 11 is cut using a dicer 50. That is, the semiconductor substrate 11 is cut along the dicing line 11a corresponding to the cutting opening 16 (see FIGS. 4A and 4B) of the coating layer 14. As shown in FIG. 5B, this produces each individual chip 20, in which the discharge port 15 and the opening 17 are formed in the coating layer 14, and the individual passage 18 and the liquid chamber 19 are formed above the semiconductor substrate 11.

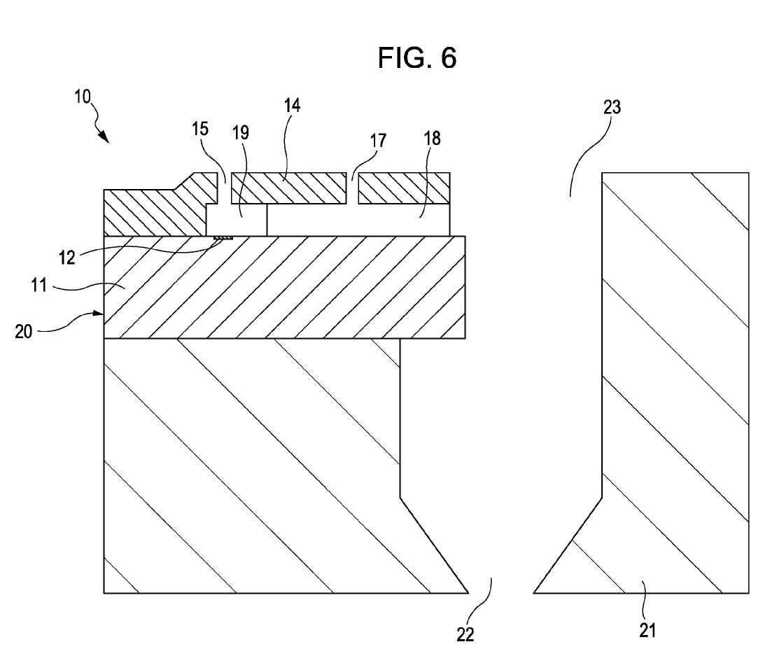

FIG. 6 shows a fifth step of bonding the chip 20 described above.

As shown in FIG. 6, the chip 20 is bonded to the ink supply member 21 in such a manner that the opening surface side of the individual passage 18 communicates with the common passage 23 (fifth step). The ink supply member 21 is made of, for example, aluminum, stainless, ceramic, or resin separately prepared by machining or the like, and has formed therein a through-hole extending through the base of the ink supply member 21 in the vertical direction in FIG. 6. Further, the lower surface side of this through-hole serves as the ink supply port 22, and the inner portion of the through-hole serves as the common passage 23.

Here, as shown in FIG. 6, the ink supply member 21 is formed such that the upper surface on the side where the chip 20 is bonded is located lower than the upper surface on the side opposite thereto across the common passage 23. Upon bonding the chip 20, the upper surface of the coating layer 14 of the chip 20 and the upper surface of the ink supply member 21 on the side where the chip 20 is not bonded become substantially flush with each other. Accordingly, as shown in FIG. 1, the top plate 24 can be bonded so as to straddle the upper surface of the coating layer 14 of the chip 20 and the upper surface of the ink supply member 21 (sealing step).

The top plate 24 is a sheet-like member formed from, for example, a resin film such as a polyimide or PET film, or a metal foil such as a nickel, aluminum, or stainless foil. As shown in FIG. 1, the top plate 24 is affixed onto the top plate bonding margin region on the coating layer 14 with an adhesive. Note that the adhesive is previously applied to the lower surface of the top plate 24 or to the top plate bonding margin region on the coating layer 14 and the upper surface of the ink supply member 21, and the affixation is effected by, for example, thermal-compression bonding.

Accordingly, the opening on the upper surface side of the ink supply member 21 bored for forming the common passage 23 is sealed by the top plate 24. That is, the opening on the upper surface side is covered by the top plate 24. The common passage 23 thus becomes a passage enclosed by the chip 20, the ink supply member 21, and the top plate 24. Further, the opening 17 of the coating layer 14 is closed by the top plate 24 since it is located within the top plate bonding margin region.

In this way, through the steps from FIGS. 3 to FIG. 6, the printer head 10 according to the first embodiment as shown in FIGS. 1 and 2 is manufactured. For the manufacture of the printer head 10, as in the related art described in Japanese Patent No. 3343875, there is no need to carry out a step of forming a through-hole in the semiconductor substrate 11. Therefore, the printer head 10 according to the first embodiment is excellent in terms of yield and can be manufactured at low cost.

Further, due to the requirement of realizing a desired bonding strength between the coating layer 14 and the top plate 24, it is required that the top plate bonding margin region on the coating layer 14 have a surface area larger than a certain value. On the other hand, as the top plate bonding margin region becomes larger, more sacrificial layer 13 becomes necessary, so the amount of elution of the sacrificial layer 13 increases. This causes an increase in the time required for eluting the sacrificial layer 13 and, as a result, the coating layer 14 is eroded by the dissolving liquid for the sacrificial layer 13, causing material defects.

However, with the printer head 10 according to the first embodiment, the sacrificial layer 13 is quickly eluted due to the opening 17, so the sacrificial layer 13 is eluted in a short time even when a large area is secured for the top plate bonding margin. Accordingly, there is no fear of the coating layer 14 being eroded. In this respect, too, the printer head 10 according to the first embodiment is excellent in terms of yield and can be manufactured at low cost.

### Second Embodiment

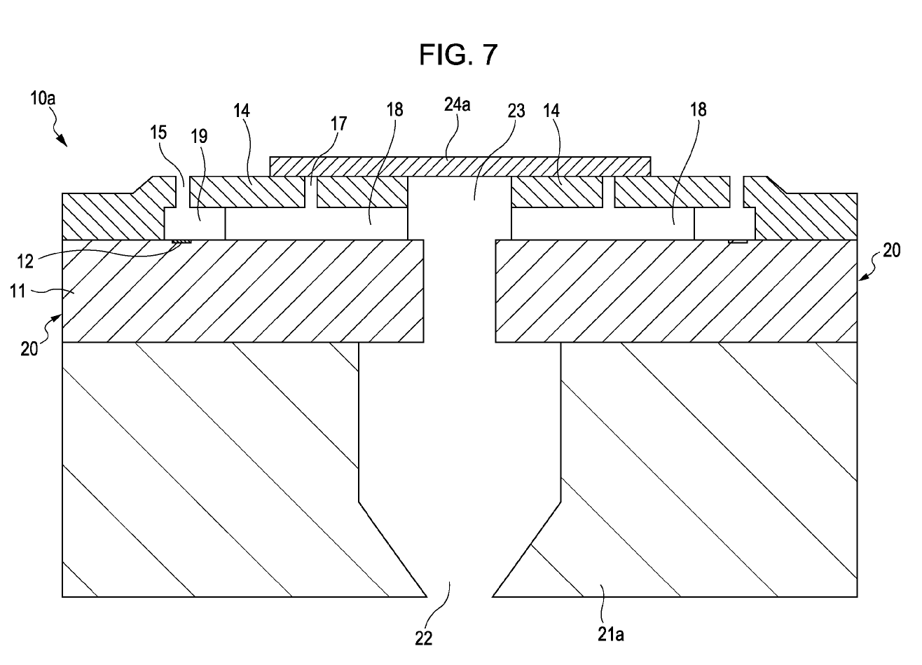

FIG. 7 is a sectional view showing a printer head 10a according to a second embodiment of the present invention. Note that the chip 20 used in the second embodiment is the same as that of the first embodiment, and that the materials of an ink supply member 21a and top plate 24a are also the same as those of the first embodiment.

As shown in FIG. 7, the printer head 10a according to the second embodiment is different from that according to the first embodiment in the number of chips 20 and the configuration of the ink supply member 21a. That is, in the first embodiment (see FIG. 1), the chip 20 is bonded to one side of the ink supply member 21 with respect to the common passage 23. In contrast, in the second embodiment shown in FIG. 7, the upper surface of the ink supply member 21a is formed flat, and the chip 20 is bonded to either side of ink supply member 21a with respect to the common passage 23 located therebetween.

In the second embodiment, as shown in FIG. 7, the opening surface sides of the individual passages 18 of the two chips 20 both face the common passage 23 side, and the respective chips 20 are arranged so as to be opposed to each other with the common passage 23 therebetween. Here, since the upper surfaces of the sides of the ink supply member 21a onto which the respective opposing chips 20 are bonded are equal in height, even when the two chips 20 are bonded respectively, the height of the upper surface of the coating layer 14 becomes equal between the two chips 20. Further, a top plate 24a is attached so as to straddle the respective coating layers 14 of the two chips 20.

As in the first embodiment, the printer head 10a according to the second embodiment as described above is also excellent in terms of yield and can be manufactured at low cost because it does not require the step of forming a through-hole in the semiconductor substrate 11. Further, since the sacrificial layer 13 is quickly eluted due to the opening 17, the coating layer 14 is not eroded even when a large area is secured for the top plate bonding margin region. Accordingly, in this respect, too, the printer head 10a according to the second embodiment is excellent in terms of yield and can be manufactured at low cost.

### Third Embodiment

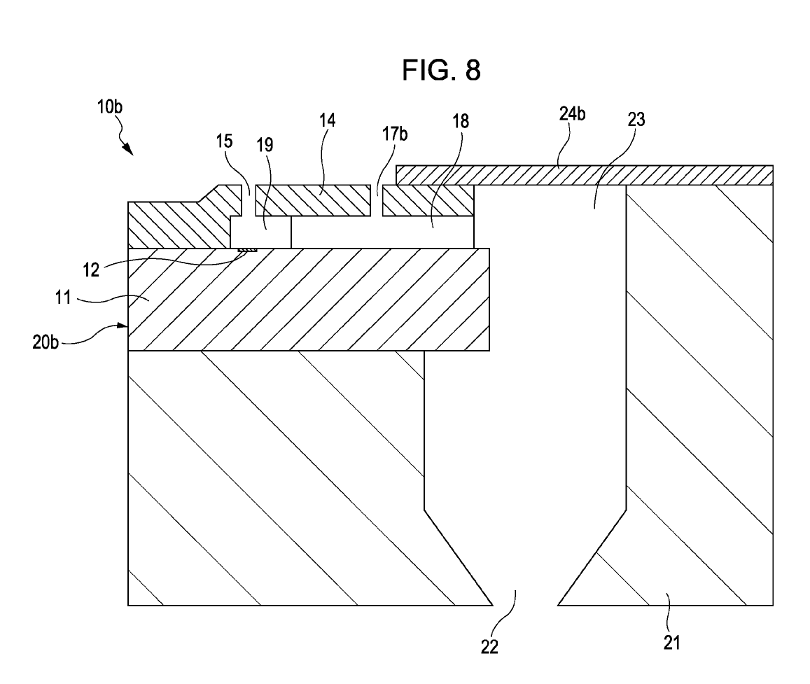

FIG. 8 is a sectional view showing a printer head 10b according to a third embodiment of the present invention. Note that the ink supply member 21 used in the third embodiment is the same as that of the first embodiment, and that the material of a top plate 24b is also the same as that of the first embodiment.

As shown in FIG. 8, the printer head 10b according to the third embodiment is different from that of the first embodiment in the size of an opening 17b formed in the coating layer 14 of a chip 20b, and the length of the top plate 24b. That is, in the first embodiment (see FIG. 1), the opening 17 of the same size and configuration as the discharge port 15 is formed, and the opening 17 is closed by the top plate 24. In contrast, in the third embodiment shown in FIG. 8, the size of the opening 17b is made slightly smaller than that of the discharge port 15, and the opening 17b is not closed by the top plate 24b.

Although the time required for eluting the sacrificial layer 13 from the opening 17b is slightly longer than that in each of the first and second embodiments, the printer head 10b according to the third embodiment as described above is the same as those of the first and second embodiments in that it is excellent in terms of yield and can be manufactured at low cost. Further, in the third embodiment, since the opening 17b is not closed after the elution of the sacrificial layer 13, the opening 17b also serves as the opening for removing bubbles present in the ink in the individual passage 18. The ink discharge characteristics thus become stable. Note that since the opening 17b is smaller than the discharge port 15, due to the surface tension of ink, there is no ink leakage from the opening 17b when the ink is discharge from the discharge port 15.

Subsequently, EXAMPLES of the present invention will be described.

### EXAMPLE 1

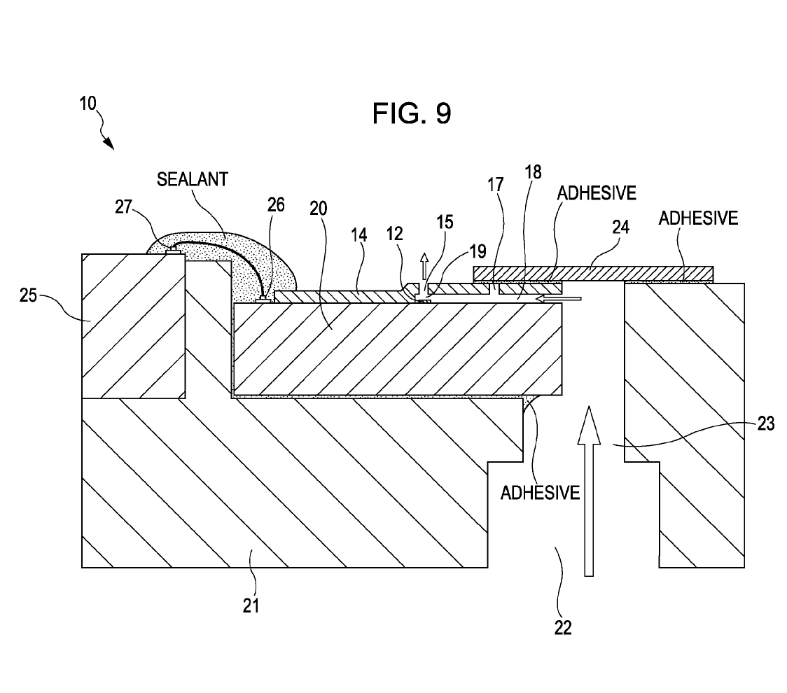

FIG. 9 is a side sectional view showing the printer head 10 according to EXAMPLE 1.

To manufacture the printer head 10 according to EXAMPLE 1, a positive photoresist PMER-LA 900 (from Tokyo Ohka Kogyo Co. Ltd.) is applied by spin coating at a film thickness of 10 μm onto a silicon wafer (semiconductor substrate) having the heater element 12 formed therein, followed by exposure using a mask aligner. After development with a developer solution (3% tramethyl ammonium hydroxide solution), the resultant is subjected to rinse treatment with pure water to thereby form a sacrificial layer having patterns of the individual passage 18 and the like formed therein. Then, the resist pattern on the sacrificial layer is subjected to full exposure using the above-described mask aligner, and the resultant is left to stand in a nitrogen atmosphere for 24 hours.

Next, a photosetting negative type photoresist is further applied by spin coating onto the resist on the sacrificial layer formed by patterning while adjusting the rotation speed so that the thickness of the film obtained becomes 10 μm, thereby forming the coating layer 14. Subsequently, the resultant is subjected to exposure using the mask aligner, followed by development and rinsing with a developer solution (OK73 thinner: from Tokyo Ohka Kogyo Co. Ltd.) and a rinsing solution (IPA), respectively. Further, the discharge port 15 (having a diameter of 15 μm) is formed above the heater element 12, and also the cutting opening above the dicing line is formed. At the same time, the opening 17 (which in EXAMPLE 1 has the same diameter, 15 μm, as that of the discharge port 15) is also formed at the middle between the discharge port 15 and the cutting opening.

Then, the positive type photoresist is immersed in an organic solvent (PGMEA) having solubility with respect to the positive type photoresist while applying ultrasonic waves until the positive type photoresist is completely dissolved and eluted. Subsequently, dicing is performed using the dicer, whereby the silicon wafer is cut into individual chips, thereby forming each individual chip 20. Note that the time required for the elution is about half of that required in the case where no opening 17 is formed. Further, no peeling failure, loss of shape, or the like of the coating layer 14 is observed in the visual inspection after the elution.

On the other hand, the ink supply member 21 is formed by machining from a stainless steel. Then, as shown in FIG. 9, the chip 20 is bonded onto the ink supply member 21 using a silicone-based adhesive in such a manner that the entrance of the individual passage 18 of the chip 20 faces the common passage 23 side. Note that the bonding condition at this time is to leave the resultant structure to stand as it is for 1 hour at ordinary temperature; it is designed in advance that the upper surface of the ink supply member 21 and the upper surface of the chip 20 becomes flush with each other in this state.

Next, a polyimide film (top plate 24) having a thickness of 25 μm and cut into a predetermined shape in advance is bonded between the upper surface of the ink supply member 21 and the upper surface of the chip 20, which have thus been made flush with each other, in conformity with the top plate bonding margin region on the coating layer 14. Thus, the top plate 24 serves to cover the upper surfaces, including the opening 17, so as to prevent ink leakage. Note that a film-like adhesive is affixed onto the top plate 24 in advance.

Thereafter, a terminal 27 of a printed circuit board 25 for driving the chip 20 and a terminal 26 (PAD) on the chip 20 are connected to each other through wire bonding, followed by sealing using a sealant (epoxy-based adhesive) so that ink does not leak from that portion.

The printer head 10 according to the first embodiment is manufactured as described above. When an ink discharge test was conducted using the printer head 10 thus manufactured, no such problems as the deflection of ink upon discharge or no ink discharge, which presumably results from peeling or deformation of the coating layer 14, were observed.

### EXAMPLE 2

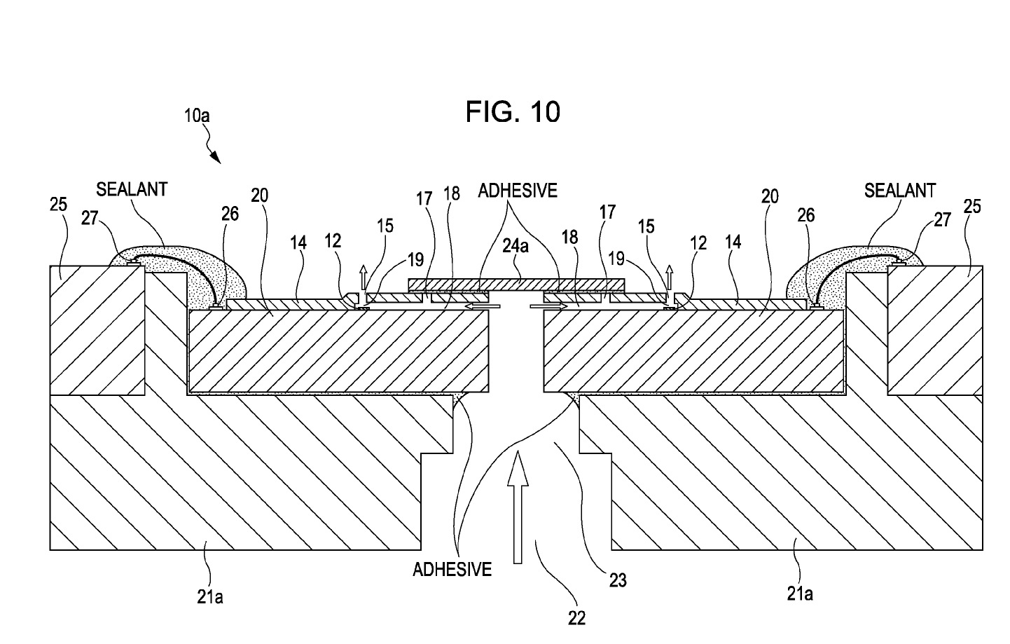

FIG. 10 is a side view showing the printer head 10a according to EXAMPLE 2 of the present invention.

With the printer head 10a according to EXAMPLE 2, two chips 20 are manufactured in completely the same manner as in EXAMPLE 1 described above, and the two chips 20 are bonded onto ink supply members 21a. That is, in EXAMPLE 2, two chips 20 are used and, as shown in FIG. 10, the two chips 20 are bonded onto the respective ink supply members 21a so that the entrances of the respective individual passages 18 of the opposing chips 20 face the common passage 23 side.

Here, the surfaces of the ink supply members 21a onto which the respective chips 20 are bonded are designed to be flush with each other. Further, the upper surfaces of the coating layers 14 of the respective chips 20 bonded onto these surfaces are flush with each other. Accordingly, as in EXAMPLE 1, the top plate 24a can be bonded between the top surfaces of the coating layers 14 of the two chips 20.

The printer head 10a according to EXAMPLE 2 is manufactured as described above. When an ink discharge test was conducted using the printer head 10a thus manufactured, no such problems as the deflection of ink upon discharge or no ink discharge, which presumably results from peeling or deformation of the respective coating layers 14, were observed.

### EXAMPLE 3

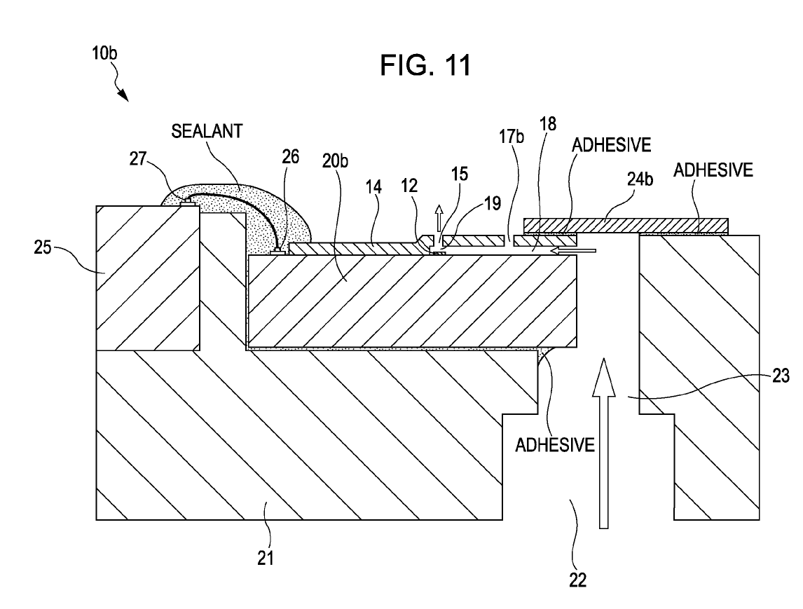

FIG. 11 is a side sectional view showing the printer head 10b according to EXAMPLE 3 of the present invention.

With the printer head 10b according to EXAMPLE 3, the chip 20b is manufactured in completely the same manner as in EXAMPLE 1 described above and bonded onto the ink supply member 21. However, in EXAMPLE 3, the size of the opening 17b of the chip 20b is smaller than the discharge port 15 (having a diameter of 15 μm), and when bonding the top plate 24b, the opening 17b is not closed by the top plate 24b. Note that the opening 17b is sized so as not to cause ink leakage.

When an ink discharge test was conducted using the printer head 10b according to EXAMPLE 3 thus manufactured, no such problems as the deflection of ink upon discharge or no ink discharge, which presumably results from peeling or deformation of the coating layer 14, were observed. Further, stable discharge characteristics were obtained as the bubbles in the ink in the individual passage 18 are removed from the opening 17b.

As described above, with the printer head 10 (10a, 10b) according to each of EXAMPLES 1 to 3, even when a large top plate bonding margin region is secured in order to enhance the bonding strength between the coating layer 14 and the top plate 20 (20a, 20b), the sacrificial layer can be eluted in a short time due to the provision of the opening 17 (17b) for eluting the sacrificial layer. As a result, there is no fear of the coating layer 14 being eroded and damaged by the dissolving liquid for the sacrificial layer, and a printer head 10 (10a, 10b) with a high yield can be manufactured.

Note that the present invention is not limited to the above-described EXAMPLES. For example, various modifications, such as those described below, can be made.

(1) While in the above-described EXAMPLES the top plate 24 is used to close the opening 17 formed in the coating layer 14, this should not be construed restrictively; instead of the top plate 24, other members may be used to close the opening 17.

(2) While in the above-described EXAMPLES the opening 17 is formed at the middle between the discharge port 15 and the cutting opening 16 so as to allow the elution of the sacrificial layer 13 from the opening 17. However, the position of the opening 17 is not limited to this. That is, the opening 17 can be formed at such a position that allows efficient elution of the sacrificial layer 13 by taking into account the respective shapes, sizes, and the like of the discharge port 15, cutting opening 16, and opening 17.

### Fourth Embodiment

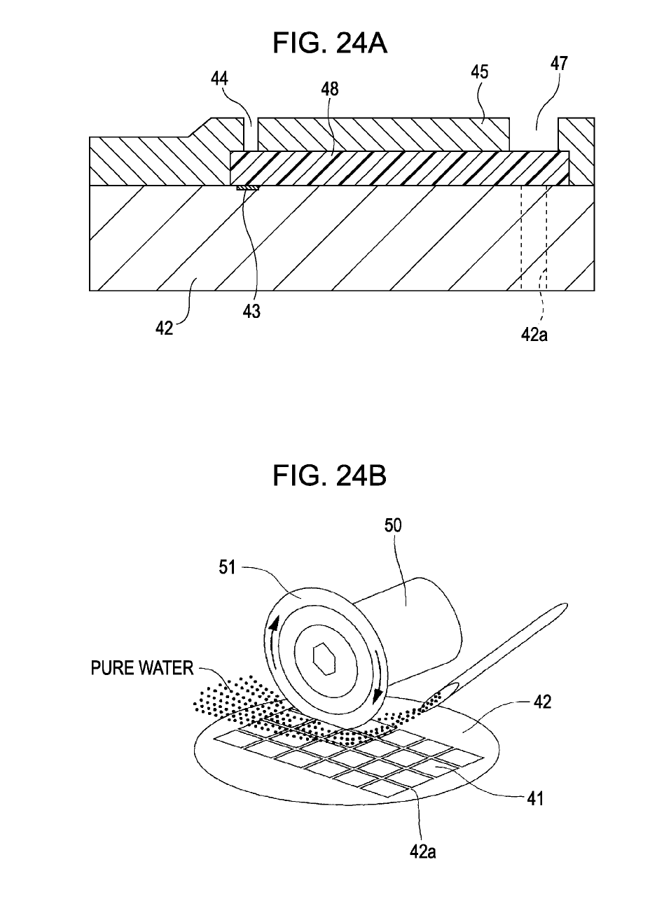

FIGS. 24A and 24B are a sectional view and a perspective view, respectively, showing a part of an improved manufacturing method for a chip 41 which does not require boring of a through-hole.

As shown in FIG. 24A, according to the improved manufacturing method, in order to elute a sacrificial layer 48 located between a semiconductor substrate 42, on which each heater element 43 is arranged, and a coating layer 45 in which a discharge port 44 is formed, an additional opening 47 is formed above a dicing line 42a along which the semiconductor substrate 42 is cut. That is, in addition to the discharge port 44, the opening 47 is formed by removing the portion of the coating layer 45 above the dicing line 42a. By using the discharge port 44 and the opening 47, the sacrificial layer 48 is eluted without forming a through-hole in the semiconductor substrate 42.

Then, after the elution of the sacrificial layer 48, as shown in FIG. 24B, the semiconductor substrate 42 is cut using the dicer 50. That is, the semiconductor substrate 42 is cut along the dicing line 42a while blasting pure water to a dicing blade 51 that is rotating at high speed, thereby forming each individual chip 41. Therefore, there is no need to form a through-hole in the semiconductor substrate 42 in manufacturing the chip 41.

However, the above-described manufacturing method involves another problem in that such defects as cracks or peeling may occur in the coating layer 45 when cutting the semiconductor substrate 42.

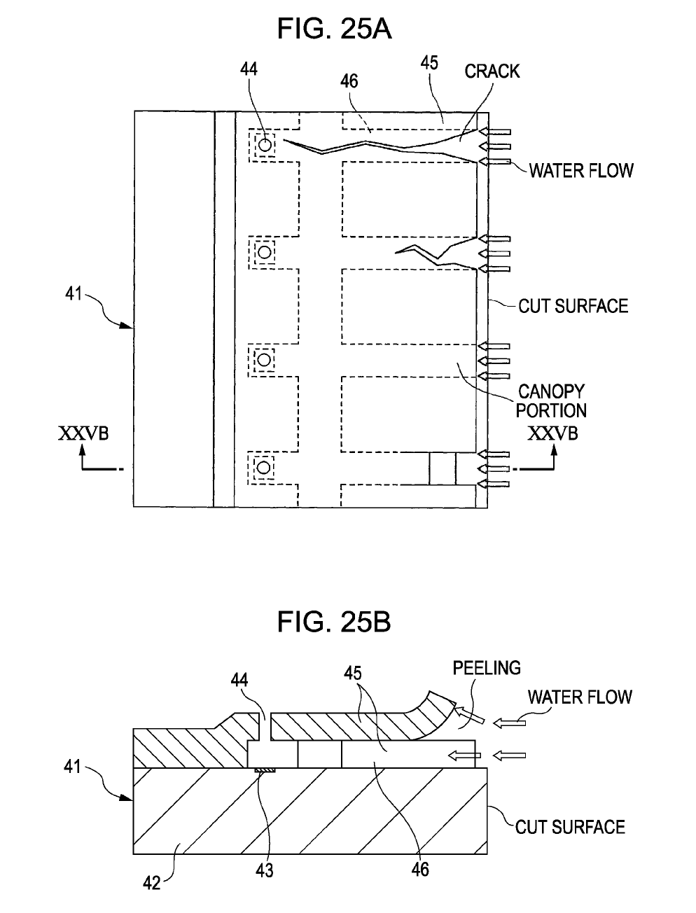

FIGS. 25A and 25B are a plan view and a side sectional view, respectively, showing defects occurring when employing the improved manufacturing method for the chip 41.

As shown in FIGS. 25A and 25B, the coating layer 45 provided with the discharge port 44 forms the left and right passage walls of each individual passage 46, and also serves as the top wall of the individual passage 46. Accordingly, the coating layer 45 is shaped like a canopy at its distal end portion close to the cut surface thereof (hereinafter, this portion will be referred to as the “canopy portion”).

Here, as the semiconductor 42 is cut with the dicer 50 (see FIG. 24B), a flow of pure water flowing from the cut surface toward the individual passage 46 is generated. A high water pressure is thus exerted on the canopy portion of the coating layer 45. Presumably, this may cause, as shown in FIG. 25A, cracking to occur in the canopy portion so a crack runs toward the discharge port 44, or may cause, as shown in FIG. 25B, the canopy portion to be pushed up by the water flow so peeling occurs in the coating layer 45.

In view of this, in this embodiment and subsequent fifth and sixth embodiments below, description will be given of a printer head adapted to prevent defects such as cracks or peeling from occurring in the coating layer while allowing the sacrificial layer to be eluted without forming a through-hole in the semiconductor substrate.

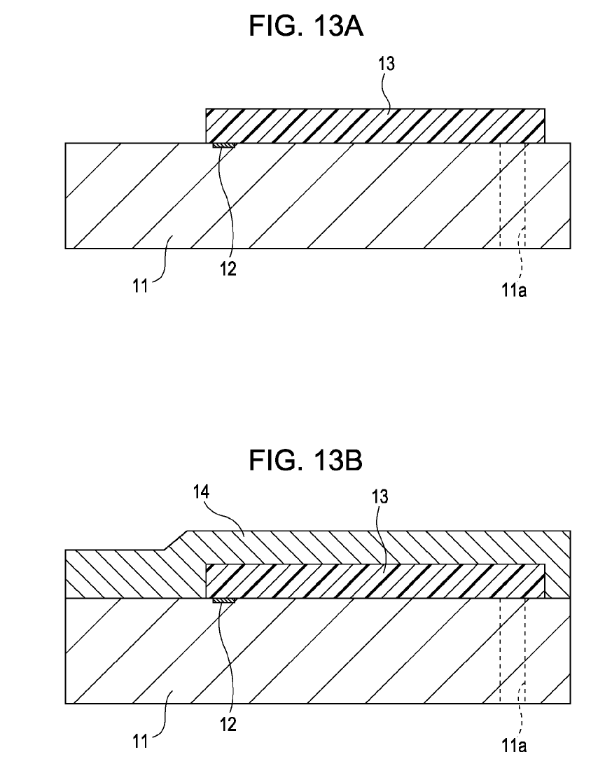

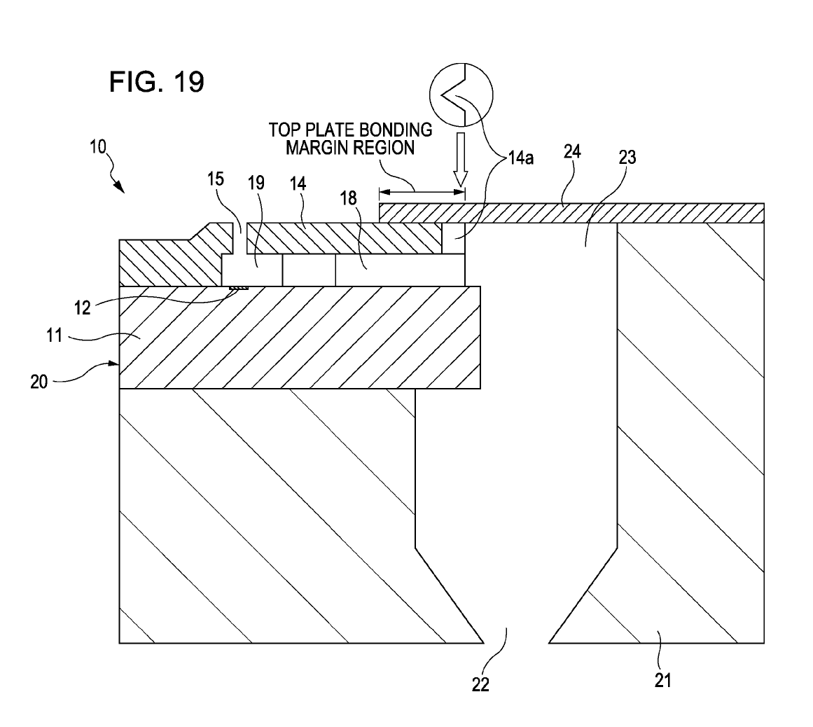

FIGS. 13A to 18 are side sectional views sequentially illustrating the intermediate steps in a method of manufacturing the printer head 10 according to the fourth embodiment. Further, FIG. 19 is a side sectional view showing the printer head 10 according to the fourth embodiment that is manufactured through the steps including those shown in FIGS. 13A to 18.

First, FIGS. 13A and 13B are side sectional views showing a first step of forming the sacrificial layer 13 on the semiconductor substrate 11 (which corresponds to the “substrate” as referred to as in the present invention), and a second step of forming the coating layer 14 on the sacrificial layer 13, respectively.

In a method of manufacturing the printer head 10 according to the fourth embodiment, as shown in FIG. 13A, the plurality of heater elements 12 (which correspond to the “energy generating elements” as referred to as in the present invention) are formed on the semiconductor substrate 11 made of silicon, glass, ceramic, or the like by, for example, a microprocessing technique for manufacturing a semiconductor or electronic device. Here, the respective heater elements 12 are arranged continuously in one direction at a predetermined pitch with respect to the direction perpendicular to the plane of FIG. 13A. In the case of the printer head 10 having a resolution of 600 DPI, for example, the pitch between the heater elements is 42.3 μm. Note that in the fourth embodiment, a silicon wafer is used as the semiconductor substrate 11.

Further, the sacrificial layer 13 is formed over a region including at least the region serving as the ink chamber above each heater element 12, the region serving as the individual passage, and the dicing line 11a of the semiconductor substrate 11 (first step). The sacrificial layer 13 is formed by applying soluble resin, for example, photosensitive resin such as a photoresist onto the semiconductor substrate 11 and the heater element 12 by spin coating or the like in order to form each ink chamber and individual passage, then forming the patterns of each ink chamber and individual passage by photolithography. That is, in the fourth embodiment, a positive photoresist PMER-LA 900 (from Tokyo Ohka Kogyo Co. Ltd.) is applied by spin coating at a film thickness of 10 μm onto the semiconductor substrate 11, followed by exposure using a mask aligner. After development with a developer solution (3% tramethyl ammonium hydroxide solution), the resultant is subjected to rinse treatment with pure water to thereby form the sacrificial layer 13 having patterns of the individual passage and the like formed therein. Then, the resist pattern on the sacrificial layer 13 is subjected to full exposure using the above-described mask aligner, and the resultant is left to stand as it is in a nitrogen atmosphere for 24 hours.

Next, as shown in FIG. 13B, a photosensitive resist is applied onto the sacrificial layer 13 by spin coating or the like, thereby forming the coating layer 14 in the region including the region where the sacrificial layer 13 is formed (second step). Specifically, a photosetting negative type photoresist is applied by spin coating onto the resist on the sacrificial layer 13 formed by patterning while adjusting the rotation speed so that the thickness of the film obtained becomes 10 μm, thereby forming the coating layer 14. Note that the coating layer 14 is a layer that functions as a commonly used nozzle sheet or barrier layer and forms a discrete structure.

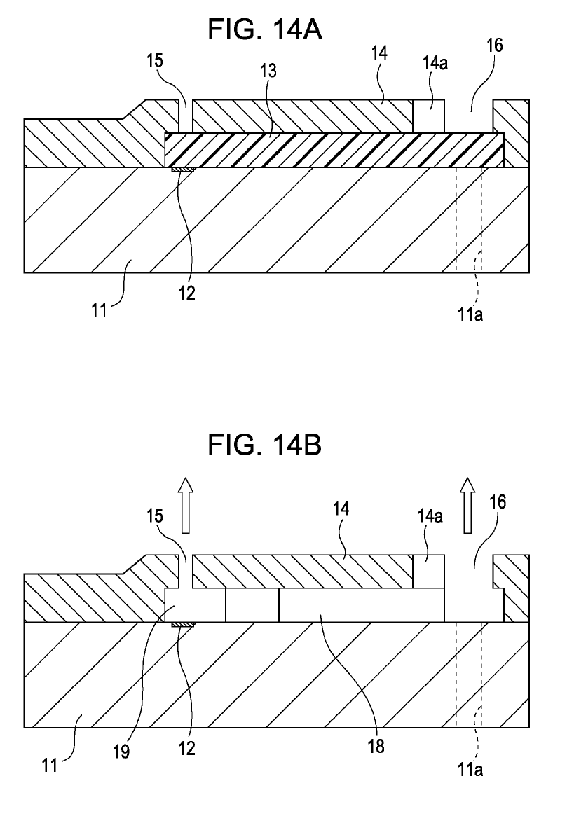

FIGS. 14A and 14B are a side sectional view showing a third step of forming the discharge port 15 in the coating layer 14 formed in the second step shown in FIG. 13B and an opening forming step of forming an opening 16, and a side sectional view showing a fourth step of eluting the sacrificial layer 13 to thereby form the individual passage 18, respectively. While the discharge port 15 and the opening 16 are formed simultaneously in the fourth embodiment, they may be formed separately during the process prior to the fourth step.

As shown in FIG. 14A, the discharge port 15 is formed at the portion of the coating layer 14 located directly above each heater element 12 (third step). At this time, when, for example, the coating layer 14 is made of photosensitive resin, the discharge port 15 is formed through patterning by photolithography so as to reach the sacrificial layer 13, that is, so as to penetrate the coating layer 14. Specifically, the coating layer 14 is subjected to exposure using the mask aligner, followed by development and rinsing with a developer solution (OK73 thinner: from Tokyo Ohka Kogyo Co. Ltd.) and a rinsing solution (IPA), respectively, thereby forming the discharge port 15 having a diameter of 15 μm.

Further, at the same time and in a similar manner, the opening 16 is formed above the dicing line 11a along which the semiconductor substrate 11 is to be cut (opening forming step). That is, the portion of the coating layer 14 above the dicing line 11a is removed to expose the sacrificial layer 13 located below the coating layer 14, thereby forming the opening 16. The mask pattern used at this time is so previously designed that the opening 16 protrudes in the form of a triangular projection toward the region that becomes the individual passage (so that a recessed portion 14a in the form of a triangular recess is formed in the coating layer 14). Note that for the simultaneous formation of the discharge port 15 and opening 16, a photomask allowing simultaneous formation of these portions may be used.

Next, the semiconductor substrate 11, the sacrificial layer 13, and the coating layer 14 are immersed in a liquid vessel filled with a dissolving liquid for dissolving the sacrificial layer 13. Then, as indicated by the arrows in FIG. 14B, the sacrificial layer 13 is eluted from each of the discharge port 15 and opening 16. That is, while applying ultrasonic waves to an organic solvent (PGMEA) having solubility with respect to a positive type photoresist, the immersion is continued until the positive type photoresist is completely dissolved and eluted. Then, the individual passage 18 extending in the direction (direction parallel to the plane of FIG. 14B) orthogonal to the direction of the arrangement (direction perpendicular to the plane of FIG. 14B) of the heater elements 12 is formed (fourth step).

When the semiconductor substrate 11, the sacrificial layer 13, and the coating layer 14 are immersed in the dissolving liquid as described above, the sacrificial layer 13 is dissolved by the dissolving liquid and fluidized so as to be eluted to the outside of the coating layer 14 from the discharge port 15 and the opening 16 as shown in FIG. 14B. On the other hand, the semiconductor substrate 11 and the coating layer 14 undergo no change in shape before and after the immersion in the dissolving liquid. Accordingly, the portion where the sacrificial layer 13 has been present becomes a void, which in turn becomes the individual passage 18 and the liquid chamber 19. Thus, after the elution of the sacrificial layer 13, the coating layer 14 forms a discrete structure, and the discharge port 15 formed in the coating layer 14 communicates with the individual passage 18. Further, the heater element 12 becomes present within the liquid chamber 19. Furthermore, the recessed portion 14a recessed in a triangular shape toward the individual passage 18 is formed in the portion of the coating layer 14 on the side opposite to the discharge port 15 across the individual passage 18.

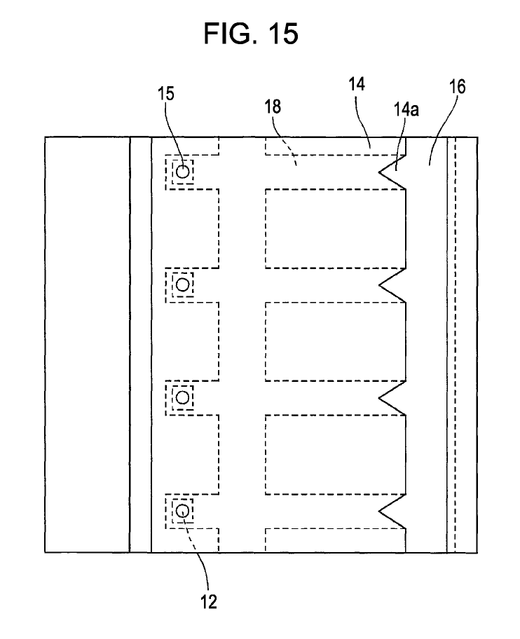

FIG. 15 is a plan view showing the state in which the steps up to the fourth steps have been finished.

As shown in FIG. 15, after the elution of the sacrificial layer 13 (see FIGS. 14A and 14B), the side surface of each individual passage 18 is defined by the coating layer 14, and the top surface of the individual passage 18 is covered by the coating layer 14. Further, in the coating layer 14, the discharge port 15 is formed so as to be opposed to each heater element 12. Further, on the opening 16 side, the triangular recessed portion 14a extending toward the individual passage 18 is formed in the coating layer 14. That is, the canopy portion of the coating layer 14 is formed by the triangular recessed portion 14a.

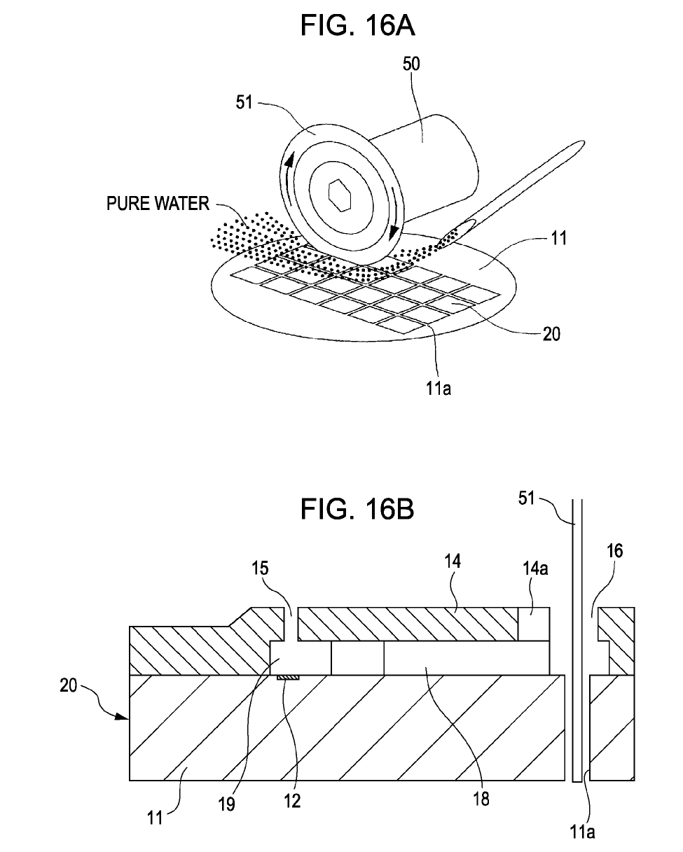

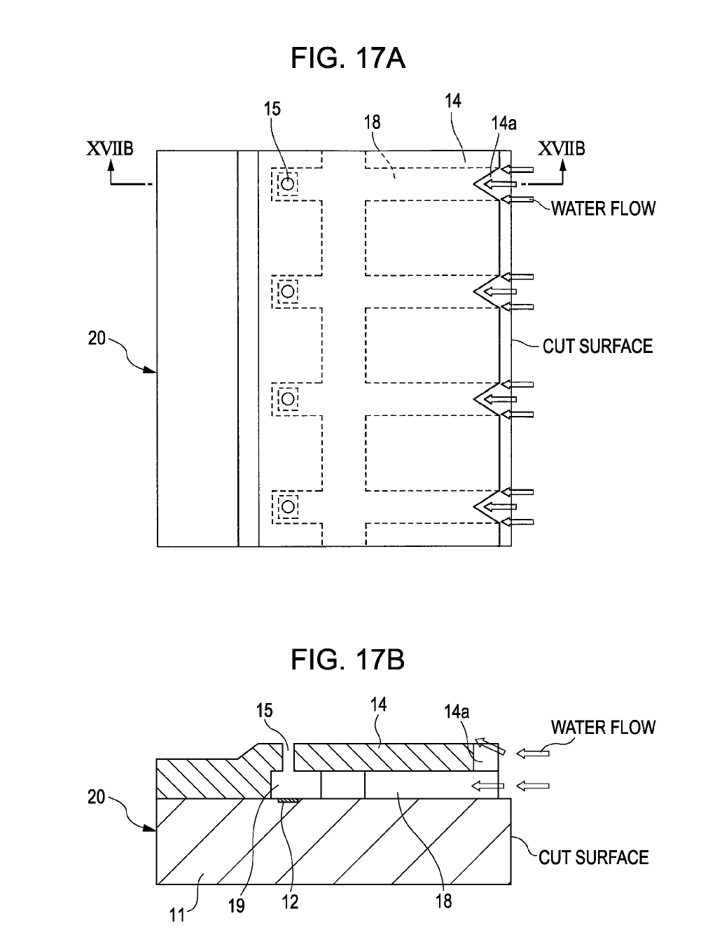

FIGS. 16A and 16B are a perspective view and a side sectional view, respectively, showing a cutting step of cutting the semiconductor substrate 11 into each individual chip 20. Further, FIGS. 17A and 17B are a plan view and a side sectional view, respectively, showing the cutting step.

As shown in FIG. 16A, in the cutting step, the semiconductor substrate 11 is cut using the dicer 50 while blasting pure water to the dicing blade 51 that is rotating at high speed. That is, as shown in FIG. 16B, the semiconductor substrate 11 is cut along the dicing line 11a of the semiconductor substrate 11 exposed by the opening 16 of the coating layer 14, thereby obtaining each individual chip 20.

At this time, as shown in FIG. 17A, the pure water blasted onto the dicing blade 51 forms a water flow flowing toward the individual passage 18. In this regard, as described above, the coating layer 14 is provided with the triangular recessed portion 14a that is recessed toward the individual passage 18. Accordingly, the water pressure (water flow acting to push up the canopy portion from below) exerted on the coating layer 14 is released by the triangular recessed portion 14a. That is, while the strength of the coating layer 14 is weakest at the portion corresponding to the laterally central portion of the individual passage 18, the water pressure becomes the weakest at that central portion. Accordingly, the chip 20 shown in FIGS. 17A and 17B is free from such defects as cracks or peeling occurring in the coating layer 14.

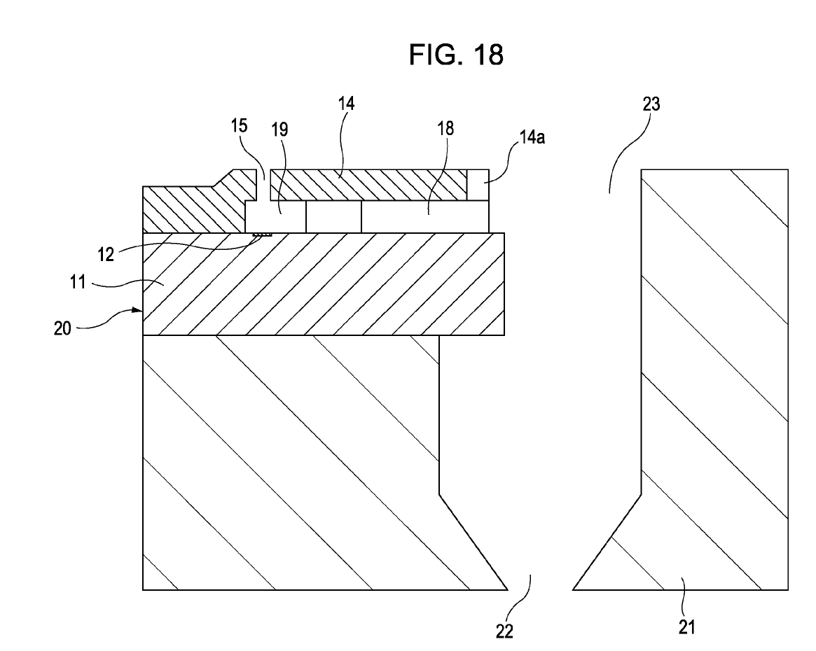

FIG. 18 is a side sectional view showing a fifth step of bonding each individual chip 20 manufactured as described above onto the ink supply member (which corresponds to the “liquid supply member” as referred to as in the present invention).

Here, the ink supply member 21 is made of, for example, aluminum, stainless, ceramic, or resin, which is prepared by machining or the like separately from the manufacture of the chip 20. The ink supply member 21 has formed therein a through-hole penetrating the base thereof in the vertical direction in FIG. 18. Further, the lower surface side of this through-hole serves as the ink supply port 22, and the inner portion of the through-hole serves as the common passage 23.

The bonding of the ink supply member 21 as described above and the chip 20 with each other is performed using a silicone-based adhesive so that the opening surface side of the individual passage 18 faces the common passage 23 side (fifth step). The individual passage of the chip 20 and the common passage 23 of the ink supply member 21 are thus communicated with each other. Note that the bonding condition at this time is to leave the resultant structure to stand as it is for 1 hour at ordinary temperature.

Further, as shown in FIG. 18, the ink supply member 21 is formed such that the upper surface on the side where the chip 20 is bonded is located lower than the upper surface on the side opposite thereto across the common passage 23. Upon bonding the chip 20, the upper surface of the coating layer 14 of the chip 20 and the upper surface of the ink supply member 21 on the side where the chip 20 is not bonded become substantially flush with each other. Accordingly, the top plate 24 (not shown), which covers the portion above the recessed portion 14a and the common passage 23, can be bonded so as to straddle the upper surface of the coating layer 14 of the chip 20 and the upper surface of the ink supply member 21 (sealing step).

FIG. 19 is a side sectional view showing the state where the top plate 24 has been bonded to form the printer head 10 according to the fourth embodiment. Note that the portion of the recessed portion 14a in the coating layer 14 is partially shown in a plan view as seen in the direction of the arrow.

As shown in FIG. 19, in the printer head 10 according to the fourth embodiment, one chip 20 is bonded onto the ink supply member 21, and the top plate 24 is affixed so as to straddle the upper surface of the chip 20 and the upper surface of the ink supply member 21.

The top plate 24 is a sheet-like member formed from, for example, a resin film such as a polyimide or PET film, or a metal foil such as a nickel, aluminum, or stainless foil. The top plate 24 is cut into a desired shape in advance and affixed onto the top plate bonding margin region on the coating layer 14. Note that the adhesive used for affixing the top plate 24 is previously applied to the lower surface of the top plate 24 or to the top plate bonding margin region on the coating layer 14 and the upper surface of the ink supply member 21. In the printer head 10 according to the fourth embodiment, a polyimide film having a thickness of 25 μm is used as the top plate 24, and a film-like adhesive is affixed onto the top plate 24 in advance, followed by thermal-compression bonding or the like to thereby effect bonding.

Further, the length of the top plate bonding margin region (the length of the portion closed by the top plate 24) is 300 μm. The deepest part (the vertex of the triangle) of the triangular recessed portion 14a is recessed within the range of 5 to 20% of the length of the top plate bonding margin region. Accordingly, upon bonding the top plate 24, the top plate 24 covers not only the portion above the common passage 23 but also covers the recessed portion 14a. Here, when the deepest part of the recessed portion 14a is recessed by more than 20% of the length of the top plate bonding margin region, the top plate bonding margin region may become insufficient, causing a lack of adhesion force. On the other hand, when the deepest part of the recessed portion 14a is recessed by less than 5% of the length of the top plate bonding margin region, it may become difficult to sufficiently release the water pressure exerted on the coating layer 14 during the above-described cutting step, causing such defects as cracks or peeling to occur in the canopy portion of the coating layer 14.

Note that a printed circuit board for driving the chip 20 is connected to the printer head 10 through wire bonding, and the portion including a terminal (PAD) of the chip and a terminal of the printer circuit board is sealed by a sealant (epoxy-based adhesive) so that ink does not contact that portion.

In this way, the printer head 10 according to the fourth embodiment shown in FIG. 19 is manufactured through the respective steps shown in FIGS. 13A to FIG. 18. Further, as shown in FIG. 19, the chip 20 forming the printer head 10 includes, on the semiconductor substrate 11, the plurality of heater elements 12 arranged in one direction, the coating layer 14 provided with the plurality of discharge ports 15 opposed to the respective heater elements 12, and the individual passages 18 extending in the direction orthogonal to the alignment direction of the heater elements 12. The region above each heater element 12 which communicates with each individual passage 18 serves as the liquid chamber 19. Further, the ink supply member 21 is provided with the ink supply port 22 and the common passage 23, and the common passage 23 communicates with the individual passage 18. Further, the portion of the ink supply member 21 penetrated for forming the common passage 23 is sealed by the top plate 24. Further, the recessed portion 14a formed in the coating layer 14 is closed by the top plate 24.

Accordingly, when ink enters the ink supply member 21 from the ink supply port 22, the ink passes through the common passage 23 and enters the individual passage 18 and liquid chamber 19 of the chip 20. When the heater elements 12 are heated in this state, bubbles are generated in the ink on the heater elements 12. Due to a pressure change at the time of this bubble generation (expansion and contraction of the bubbles), a part of the ink is discharged from the discharge port 15 in the form of an ink droplet.

Further, with the printer head 10 according to the fourth embodiment shown in FIG. 19, no such problems as ink leakage or ink discharge failure, which presumably result from cracking or peeling of the coating layer 14, were observed. That is, with the printer head 10 according to the fourth embodiment, due to the recessed portion 14a formed in the coating layer 14, there is no fear of the coating layer 14 being cracked or peeled, whereby the printer head 10 obtained provides high yield and is stable in terms of quality.

### Fifth Embodiment

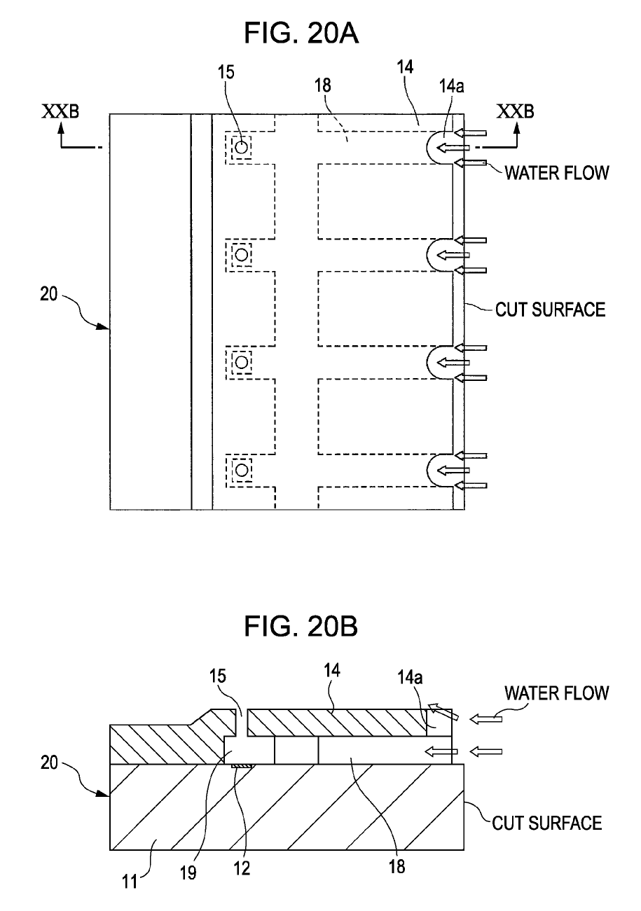

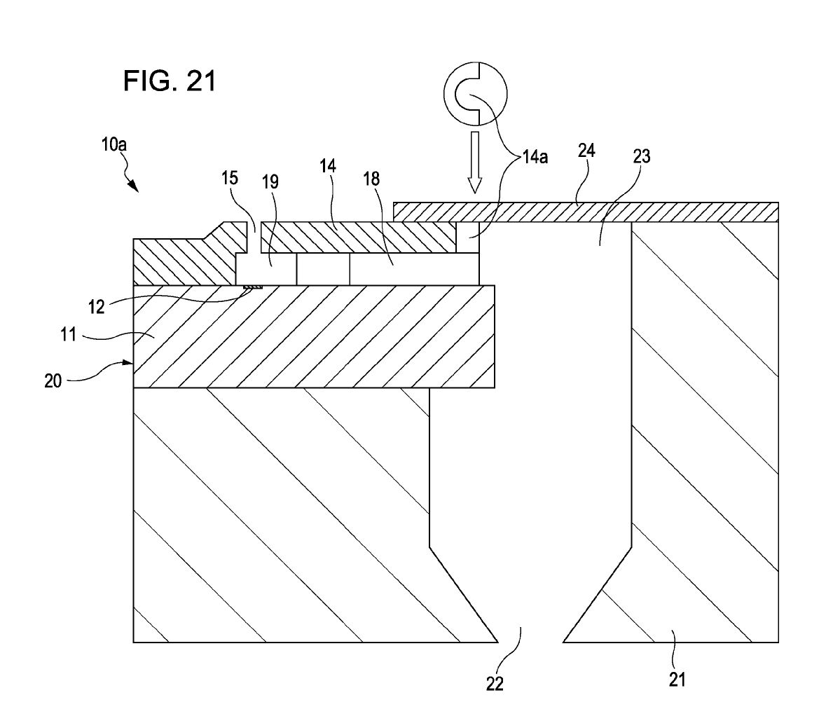

FIGS. 20A and 20B are a plan view and a side sectional view, respectively, showing a cutting step in a method of manufacturing a printer head 10a according to a fifth embodiment of the present invention. Further, FIG. 21 is a side sectional view showing the printer head 10a according to the fifth embodiment.

Although the printer head 10a according to the fifth embodiment is manufactured in the same manner as that of the fourth embodiment, as shown in FIGS. 20A, 20B, and 21, the fifth embodiment differs from the fourth embodiment in the configuration of the recessed portion 14a of the coating layer 14. That is, while in the fourth embodiment (see FIGS. 17A and 17B) the recessed portion 14a has the shape of a triangular recess, in the fifth embodiment, the recessed portion 14a has the shape of a semi-circular recess.

In the case of the printer head 10a according to the fifth embodiment as described above, as in the fourth embodiment, the water flow of the pure water blasted onto the dicing blade 51 (see FIG. 16A) that is rotating at high speed in the cutting step is released through the semi-circular recessed portion 14a, so the water pressure acting on the coating layer 14 sequentially decreases. Accordingly, there is no fear of the coating layer 14 being cracked or peeled during the cutting step. Further, a printer head 10a that provides high yield and is stable in terms of quality can be obtained.

### Sixth Embodiment

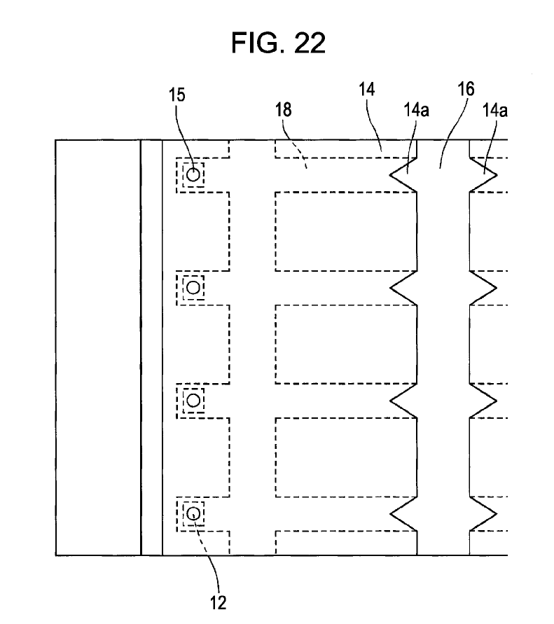

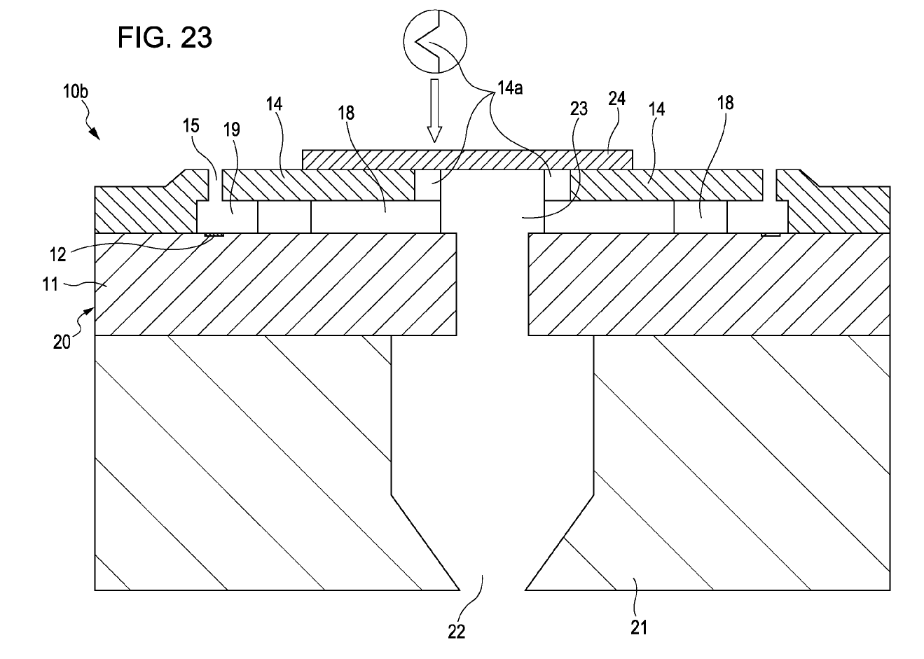

FIG. 22 is a plan view showing the state in which the steps up to the fourth step have been finished in a method of manufacturing a printer head 10b according to a sixth embodiment of the present invention. Further, FIG. 23 is a side sectional view showing the printer head 10b according to the sixth embodiment.

As shown in FIG. 22, the sixth embodiment differs from the fourth embodiment in that the triangular recessed portion 14a is formed on either side of the opening 16. That is, while in the fourth embodiment (see FIG. 15) the heater element 12, the coating layer 14, the recessed portion 14a, the discharge port 15, and the individual passage 18 are formed only on the left side of the opening 16, in the sixth embodiment, the heater element 12, the coating layer 14, the recessed portion 14a, the discharge port 15, and the individual passage 18 are formed so as to be symmetrical with respect to the opening 16.

In the case of the printer head 10b according to the sixth embodiment as described above, as in the fourth embodiment, the water flow of the pure water blasted onto the dicing blade 51 (see FIG. 16A) that is rotating at high speed in the cutting step is released through the recessed portion 14a provided on either side of the opening 16, whereby neither of the coating layers 14 on the right and left sides undergoes cracking or peeling. Further, in the cutting step, the chip 20 can be cut out from both the right and left sides of the opening 16.

Further, as shown in FIG. 23, the printer head 10b according to the sixth embodiment differs from that of the fourth embodiment in the number of the chips 20 and the configuration of the ink supply member 21. That is, in the fourth embodiment (see FIG. 19), the chip 20 is bonded only to the ink supply member 21 located on the left side with respect to the common passage 23. In contrast, in the sixth embodiment shown in FIG. 23, the upper surface of the ink supply member 21 is formed flat, and the chip 20 are bonded to each of the right and left sides of the ink supply member 21 located symmetrically with respect to the common passage 23.

Accordingly, in the sixth embodiment, the opening surface sides of the individual passages 18 of the two chips 20 both face the common passage 23 side, and the respective chips 20 are arranged so as to be opposed to each other with the common passage 23 therebetween. Here, since the upper surfaces of the sides of the ink supply member 21 onto which the respective opposing chips 20 are bonded are equal in height, even when the two chips 20 are bonded respectively, the height of the upper surface of the coating layer 14 becomes equal between the two chips 20. Further, the top plate 24 is attached so as to straddle the respective coating layers 14 of the two chips 20.

In the case of the above-described printer head 10b according to the sixth embodiment as well, no such problems as ink leakage or ink discharge failure, which presumably result from cracking or peeling of the coating layer 14, were observed. That is, with the printer head 10b according to the sixth embodiment as well, due to the recessed portion 14a formed in the coating layer 14, there is no fear of the coating layer 14 being cracked or peeled, whereby the printer head 10b obtained provides high yield and is stable in terms of quality.

Note that the present invention is not limited to the above-described embodiments. For example, the present invention can accommodate various modifications as described below. That is, in this embodiment, the recessed portion 14a formed as a triangular or semi-circular recess is formed in the coating layer 14. However, the configuration of the recessed portion 14a is not limited to this. That is, the recessed portion 14a may be formed in any configuration as long as it allows the water pressure (water flow acting to push up the canopy portion from below) exerted on the coating layer to be released in the cutting step.

### Seventh Embodiment

In this embodiment, description will be given of a structure in which a driver element region, a heater element region, and a control circuit region are arranged in this order from a side surface end portion of a semiconductor chip which contacts a common liquid passage, toward the side where an ink chamber is arranged.

Note that techniques that are well known or publicly known in the technical field to which the present invention belongs are applied to the portions not specifically illustrated or described in this specification.

Further, the element structure or the manufacturing method described below represents only one embodiment of the present invention and should not be construed as limiting the scope of the present invention.

### (A) MANUFACTURING PROCESS FOR LIQUID DISCHARGE HEAD

Here, description will be given of the case of manufacturing a liquid discharge head (hereinafter, referred to as the “printer head”) of a type (thermal type) which ejects ink droplets using the pressure of bubbles generated through heating by heater elements.

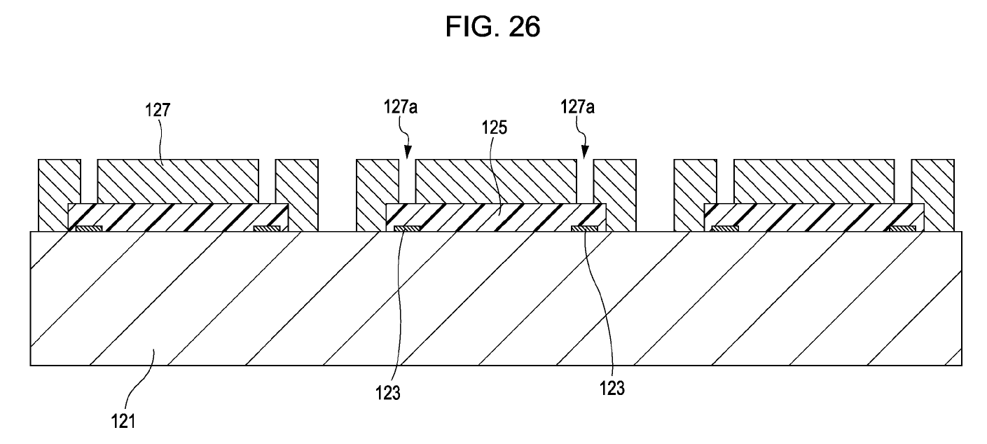

FIGS. 26 to 30 each show an example of the manufacturing process for the printer head. Note that the printer head refers to a printer head formed by mounting a chip device (assembly part) to a base, the chip device having a nozzle formed by machining in a coating layer coated on the surface of a chip element having liquid discharge circuit elements integrated thereon.

First, as shown in FIG. 26, circuit elements are formed on a semiconductor substrate 121. Silicon, glass, ceramic, or the like, for example, is used as the material for the base forming the semiconductor substrate 121. Heater elements 123 are formed on a semiconductor layer on the surface of the semiconductor substrate 121 by a semiconductor manufacturing technique (first step).

Here, the heater elements 123 are formed in the longitudinal direction of the semiconductor substrate 121 at the same interval as the nozzle pitch. In the case of FIG. 26, the direction perpendicular to the plane of FIG. 26 corresponds to the longitudinal direction of the semiconductor substrate 121. When manufacturing a print head of 600 DPI, for example, the heater elements 123 are formed at an interval of 42.3 (μm). In the case of the semiconductor substrate shown in FIG. 26, six chip elements can be cut out from the semiconductor substrate at a time.

In this step, driver elements and a control circuit are also formed on the semiconductor layer on the surface of the semiconductor substrate 121. The arrangement pattern for circuit elements will be described later.

Next, a sacrificial layer 125, which corresponds to each of individual passages for introducing ink to individual liquid chambers, is formed by patterning (second step). For example, a soluble resin material is used for the sacrificial layer 125.

Next, the surface (including the sacrificial layer 125) of the semiconductor substrate 121 is coated with a coating layer 127 (third step). A photo-setting epoxy resin, for example, is used for the coating layer 127. The application of the coating layer 127 is performed by, for example, spin coating.

Next, nozzles 127a are formed in the coating layer 127 (fourth step). Each nozzle 127a is formed so as to be located directly above each heater element 123. Here, the nozzle 127a is formed so as to reach the sacrificial layer 125 at its lower end (bottom). That is, the nozzle 127a is formed so as to penetrate the coating layer 127.

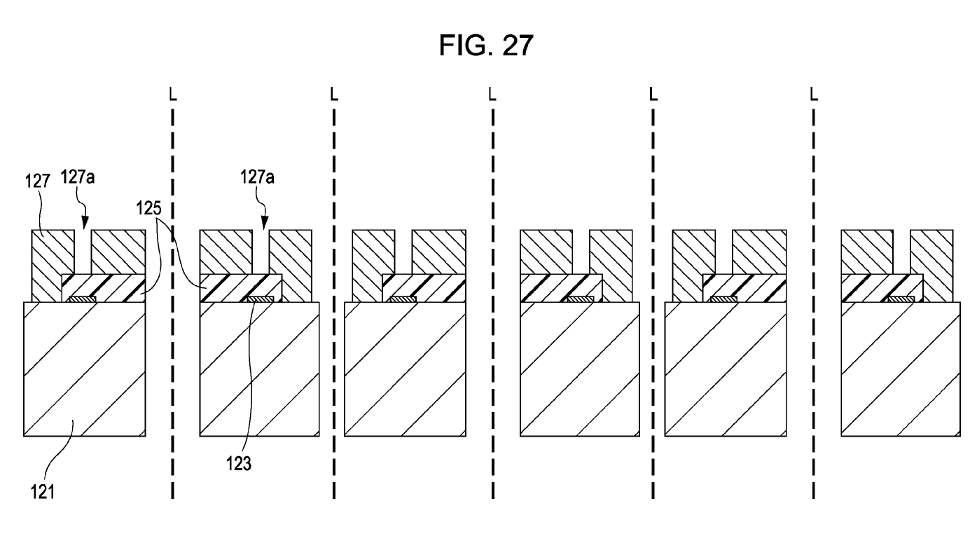

Next, as shown in FIG. 27, the semiconductor substrate 121 is cut into a plurality of chip elements at the positions of cutting lines L (fifth step). The cutting of the semiconductor substrate 121 is performed using, for example, a dicer. Each cutting line L is set at the intermediate position between adjacent heater elements 123. In the case of FIG. 27, six chip elements are cut out from the single semiconductor substrate 121. Note that in the case of FIG. 27, the cross-sectional structures of two adjacent chip elements are bilaterally symmetrical. Through this cutting process, chip elements with the sacrificial layer 125 exposed on one side surface thereof are formed.

As described above, the cutting of the semiconductor substrate 121 is executed prior to removal of the sacrificial layer 125. In this regard, it is not desirable to remove the sacrificial layer 125 prior to the cutting of the semiconductor substrate 121 because the void space formed after the removal of the sacrificial layer 125 becomes a relief portion and this adversely affect the accuracy of machining.

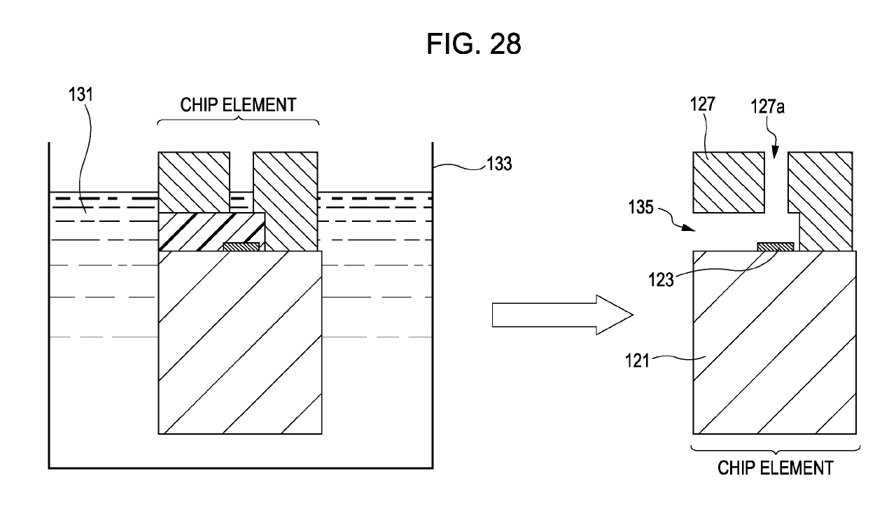

Next, the sacrificial layer 125 is removed from each chip element (sixth step). FIG. 28 shows an example of such removal. FIG. 28 shows a method of immersing the chip element in a liquid vessel 133 filled with a dissolving liquid 131. The dissolving liquid 131 to be used is selected in accordance with the material of the sacrificial layer 125.

When the chip element is immersed into the dissolving liquid 131, only the sacrificial layer 125 is dissolved and caused to flow out (eluted) to the outside of the chip element. At this time, the coating layer 127 is not dissolved in the dissolving liquid 131 and thus no change occurs in the shape of the coating layer 127. As a result, a void is formed only in the portion where the sacrificial layer 125 has been present. This void serves as each individual passage 135 including a liquid chamber. The individual passage 135 thus formed communicates with the nozzle 127a.

Note that the sacrificial layer 125 may be removed by blasting the dissolving liquid 131 toward the side surface of the chip element.

Through the above-described process, a chip element having the individual passage 135 formed on the inner side of the coating layer 127 is completed.

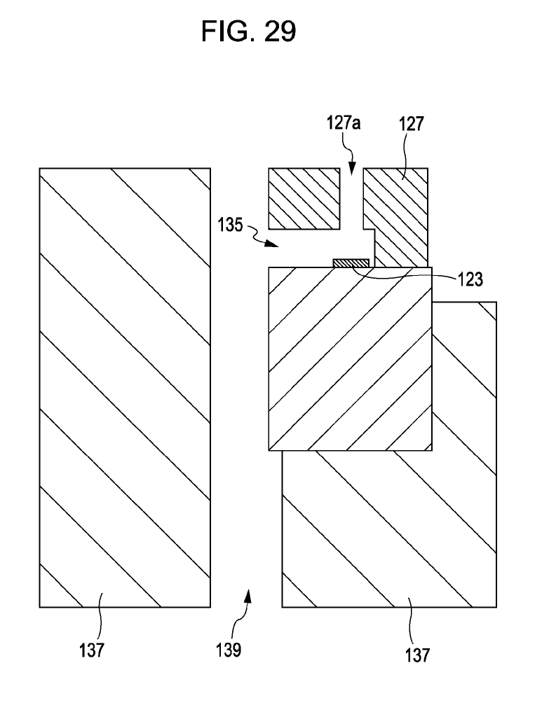

Next, as shown in FIG. 29, the chip element is bonded onto a base 137 of a print head (seventh step). Aluminum, stainless steel, ceramic, resin, or the like, for example, is used as the material of the base 137.

In this embodiment example, a through-hole corresponding to a common passage 139 is formed in the base 137. The chip element is bonded onto a stepped portion formed in a part of the inner wall forming this through-hole. The bonding is performed using, for example, an adhesive. The side surface of the chip element where the opening of the individual passage 135 is present forms the inner wall surface of the common passage 139 together with the base 139.

Note that the stepped portion is formed at a height one step lower than the opposing surface side so that the chip element and the surface of the base 137 become flush with each other upon mounting the chip element.

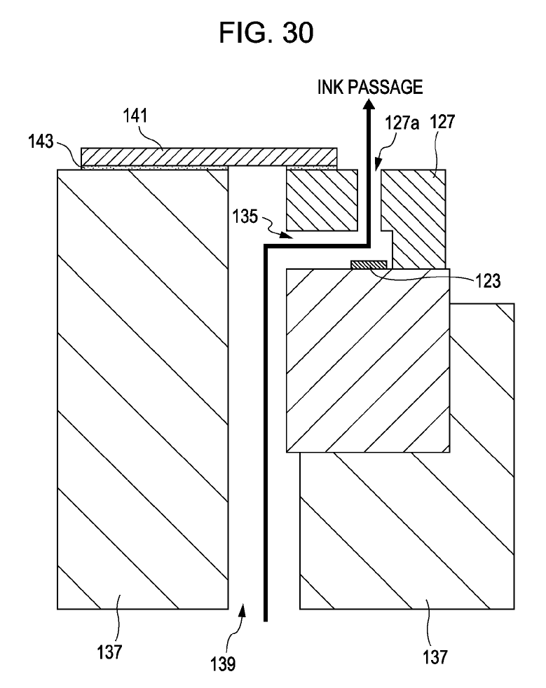

After thus completing the bonding of the chip element onto the base 137, as shown in FIG. 30, the opening of the common passage 139 which is exposed on the upper surface of the base 137 is sealed integrally with the upper surface of the chip element (eighth step). A top plate 141 (sealing member) is used to seal the opening.

The top plate 141 is a sheet-like member. A polyimide PET, or other such resin film, or a nickel, aluminum, stainless, or other such metal foil, for example, is used as the material of the top plate 141. Note that the top plate 141 and the base 137 (including the chip element) are bonded to each other through an adhesive layer 143 therebetween. The opening on the upper surface side of the common passage is completely closed by the top plate 141 thus bonded. Note that a waterproof silicone-based adhesive is used as the adhesive.

Due to the seal provided by the top plate 141, an ink passage extending from the common passage 139 to the nozzle 127a via the individual passage 135 is formed.

Note that ink droplet discharge is achieved by heating the heater element 123 in the state where ink is filled in a lower region (space where the heater element 123 is formed) of the nozzle 127a. That is, the ink is partially changed into a droplet due to a change in the pressure of bubbles (expansion and contraction of the bubbles) that grow from the surface of the heated heater element 123, and discharged to the outside from the nozzle 127a. In FIG. 30, the flow of ink is indicated by the arrows.

### (B) ARRANGEMENT EXAMPLE OF CIRCUIT ELEMENT

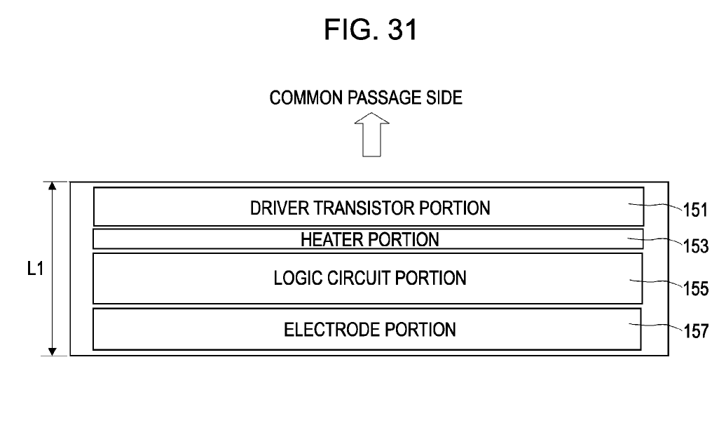

FIG. 31 shows an example of the circuit pattern for the chip element proposed in this specification. FIG. 31 is a view of the entire chip element as seen from the upper surface side.

In the case of this chip element, a driver transistor portion (driver element region) 151, a heater portion (heater element region) 153, a logic circuit portion (control circuit portion) 155, and an electrode portion 157 are arranged in the stated order from an end portion of the chip element on the side that comes into contact with the common passage upon mounting the print head to the base, toward the side where the ink chamber is formed.

The driver transistor portion 151 is a region where driver elements for driving heater elements are longitudinally arranged. A transistor is used as each of the driver elements. When the transistor is ON, a driving current is supplied to the heater element. When the transistor is OFF, the supply of the driving current is stopped.

The heater portion 153 is a region where the heater elements are longitudinally arranged. The heater elements are arranged at the nozzle pitch. Note that a resistor is used as each of the heater elements. The heater element generates heat when supplied with the driving current. When the liquid chamber is filled with ink, ink droplets are discharged to the outside from the nozzle by the pressure of bubbles growing due to the heat generation of the heater element.

The logic circuit portion 155 is a region where circuit elements (control circuit elements) for controlling the operation of the driver elements are arranged.

The electrode portion 157 is a terminal for supplying power required for driving the circuit elements formed on the chip element. Two types of electrode are prepared as the electrode, one for the supply of a power source potential (VDD) and another one for the supply of a ground potential (GND).

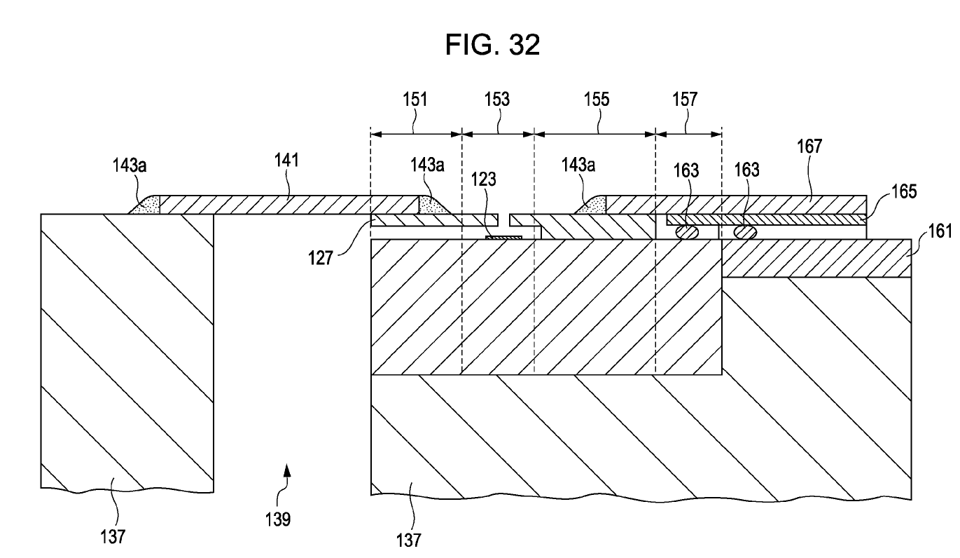

FIG. 32 shows a partial sectional structure of the printer head. As shown in FIG. 32, the top plate 141 for sealing the upper opening of the common passage 139 is bonded onto the coating layer 127 at the position of the upper surface of the driver transistor portion 151 of the chip element. The ends of the top plate 141 are sealed by adhesives 143a. That is, the region where the driver transistor portion 151 is arranged serves as the overlap width region.

Note that FIG. 32 also shows the connecting structure between an electrode exposed on the surface of the chip element and a printed circuit board 161 (bonded onto the base 137). The electrode of the electrode portion 157 is connected to the printer circuit board 161 via a bump 163, a conductor layer 165, and a bump 163. Incidentally, the upper surface thereof is covered with a protective layer 167.

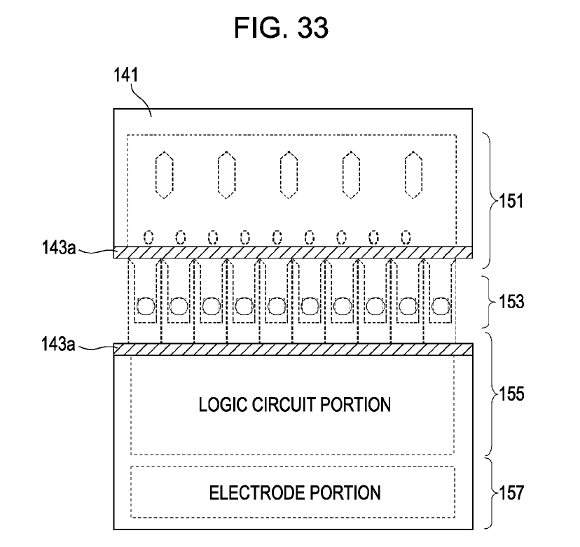

FIG. 33 is a see-through plan view, as seen from above, of the structure of the printer head. The top plate 141 and a coating layer 167 are formed so as to extend to the vicinity of the both sides of the heater portion 153.

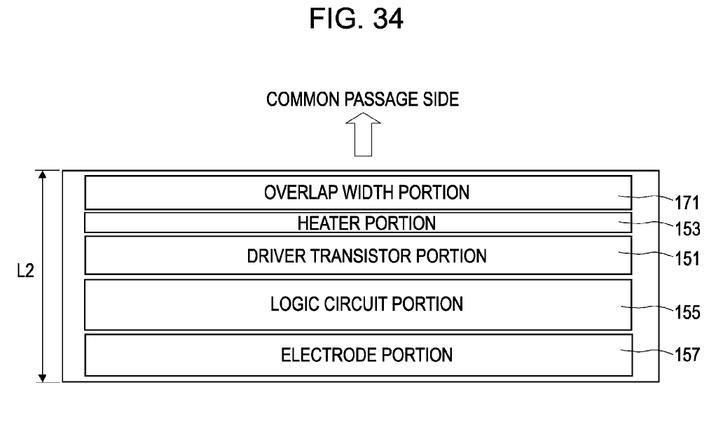

FIG. 34 shows another circuit pattern example for the chip element. In FIG. 34, the portions corresponding to those of FIG. 31 are denoted by the same reference numerals.

The structure shown in FIG. 34 differs from that shown in FIG. 31 in the following two points: the order in which the driver transistor portion 151 and the heater portion 153 are arranged is reversed; and an overlap width portion 171 is provided. The overlap width portion 171 is a region that becomes necessary due to the change in the arranging order of the driver transistor portion 151 and the heater portion 153. This is because the top plate 141 cannot be bonded onto the upper surface of the heater portion 153.

The provision of the overlap with region 171 allows the arrangement of the heater portion 153, the driver transistor portion 151, and the logic circuit portion 155 in this order.

Note that the width L2 of the chip element having the structure shown in FIG. 34 becomes larger than the width L1 of the chip element having the structure shown in FIG. 31 by the amount corresponding to the overlap width portion 71. This is because the driver transistor portion 151, the heater portion 153, the logic circuit portion 155, and the electrode portion 157 all have the same size.

Accordingly, from the viewpoint of manufacturing cost, the chip element of the structure shown in FIG. 31 with the narrow chip width proves more advantageous than the chip element of the structure shown in FIG. 34.

By adopting the circuit arranged shown in FIG. 31 as the chip element structure, the number of chip elements that can be cut out from one semiconductor substrate can be increased. This enables a corresponding decrease in the per-unit manufacturing cost of the chip element. Hence, the inventors of the prevent invention recommend the circuit arrangement shown in FIG. 31.

### (C) ARRANGEMENT EXAMPLE OF WIRING PATTERN

Next, an arrangement example of the wiring pattern for power source potential (VH) and the wiring pattern for ground potential (GND) will be described. There are two kinds of wiring pattern arrangement, a one-layer type arrangement and a two-layer type arrangement.

(a) One-Layer Type

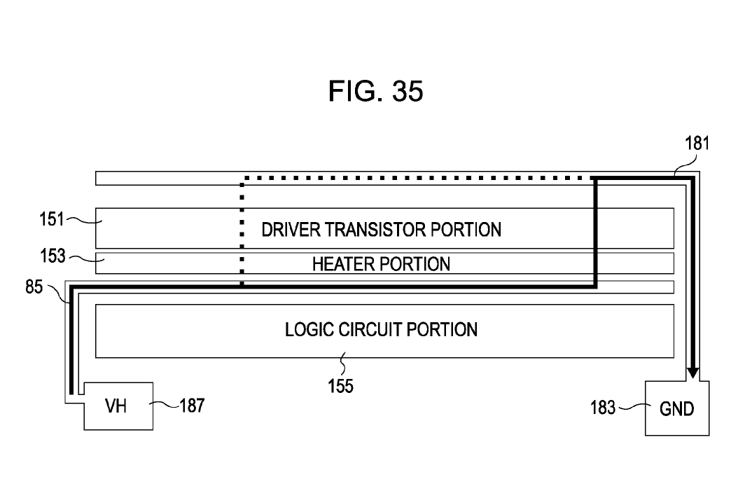

FIG. 35 shows an arrangement example of a one-layer type wiring pattern. In the arrangement example shown in FIG. 35, one electrode is used for the power source potential (VH), and one electrode is used for the ground potential (GND).

In the case of FIG. 35, a wiring pattern 181 for the ground potential (GND) is arranged in an L shape from an electrode 183 so that one side of the wiring pattern 181 extends along the outer edge of the driver transistor portion 151. On the other hand, a wiring pattern 185 for the power source potential (VH) and ground potential (GND) is arranged in an L shape from an electrode 187 so that one side of the wiring pattern 185 extends between the heater portion 153 and the logic circuit portion 155.

FIG. 35 also shows the current supply paths for currents supplied to two arbitrarily selected heater elements. The supply path length is the same in either of the cases. Of course, the supply path length for another heater element also becomes the same.

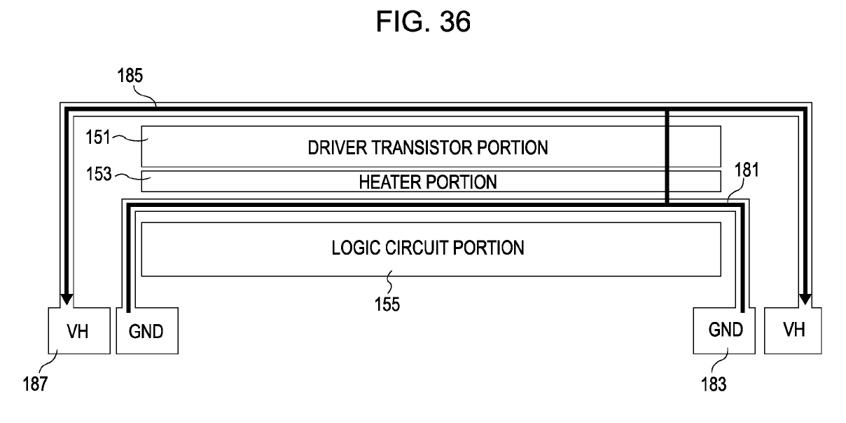

FIG. 36 shows another arrangement example of the wiring pattern. In the arrangement example shown in FIG. 36, two electrodes are used for each of the power source potential (VH) and ground electrode (GND). In this case as well, the supply path lengths for currents flowing to arbitrary heater elements are the same.

In the case of FIG. 36, the supply path for a current flowing into the heater element and the supply path for a current flowing out of the heater element can each be branched in two directions.

As a result, the effective resistance between the heater element and the electrode for each potential can be made small. That is, the effective wiring length can be reduced, which enables a corresponding reduction in the energy consumed in the wiring portion. As a result, the energy that can be applied to the heater element can be made larger than that in the arrangement of FIG. 35.

Note that as the applied energy increases, so does the discharge speed of ink droplets. It is thus possible to reduce the time required for the ink droplets to impact the recording medium.

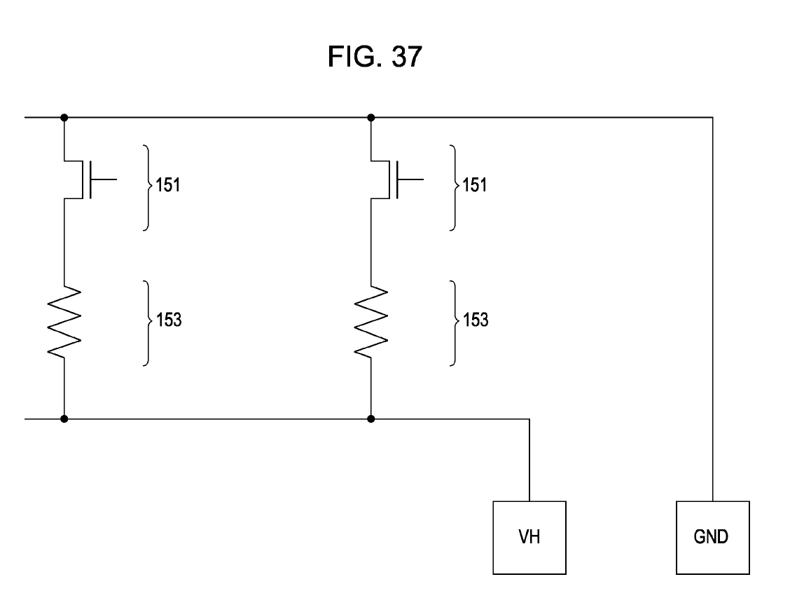

FIG. 37 shows an equivalent circuit corresponding to the wiring pattern shown in each of FIGS. 35 and 36.

(b) Two-Layer Type

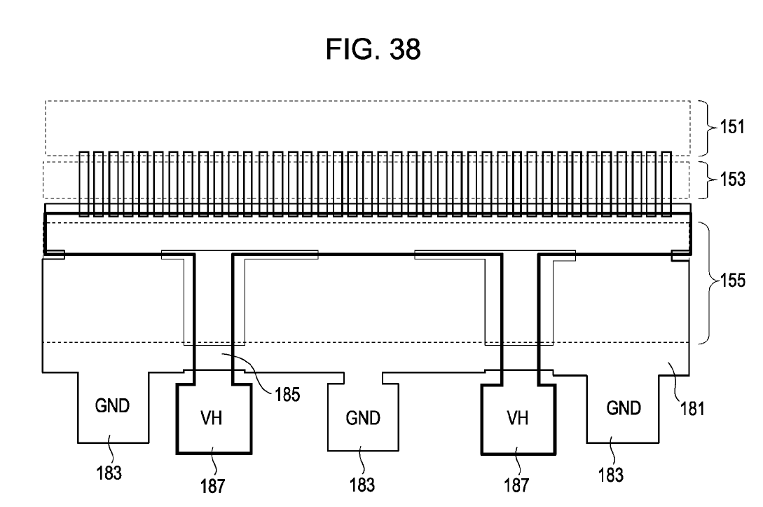

FIG. 38 shows an arrangement example of a two-layer type wiring pattern. In the arrangement example shown in FIG. 38, the wiring pattern for the ground potential (GND) is arranged in the first layer (lower level layer), and the wiring pattern for the power source potential (VH) is arranged in the second layer (upper level layer). In FIG. 38, the wiring pattern for the ground potential is indicated by the thick line, and the wiring pattern for the power source potential is indicated by the thin line.

Since the wiring patterns can be arranged separately in two-layers, the wiring pattern for the ground potential (GND) and the wiring pattern for the power source potential (VH) can be arranged along the outer longitudinal edge of the heater portion 153. As a result, respective electric potentials can be supplied to the corresponding elements from the respective wiring patterns arranged along the outer longitudinal edge of the heater portion 153.

Note that FIG. 38 shows the case where a plurality of electrodes are provided for each potential. That is, the arrangement of FIG. 38 is the same as that in the case where two electrodes are provided for each potential in the one-layer type wiring pattern (FIG. 36). Accordingly, in the case of this two-layer type wiring pattern as well, it is possible to provide one electrode for each potential.

In this connection, in FIG. 38, two electrodes are provided for the power source potential (VH), and three electrodes are provided for the ground potential (GND). Accordingly, the effective resistance between the heater element and the electrode for each potential can be made small. That is, FIG. 38 shows an arrangement in which the effective wiring length is reduced to thereby increase the energy that can be applied to the heater element.

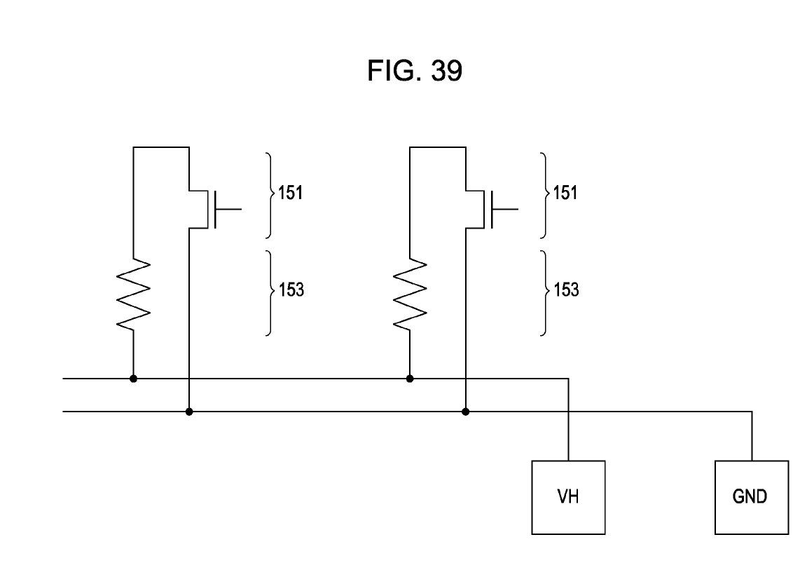

FIG. 39 shows an equivalent circuit corresponding to the wiring pattern shown in FIG. 38.

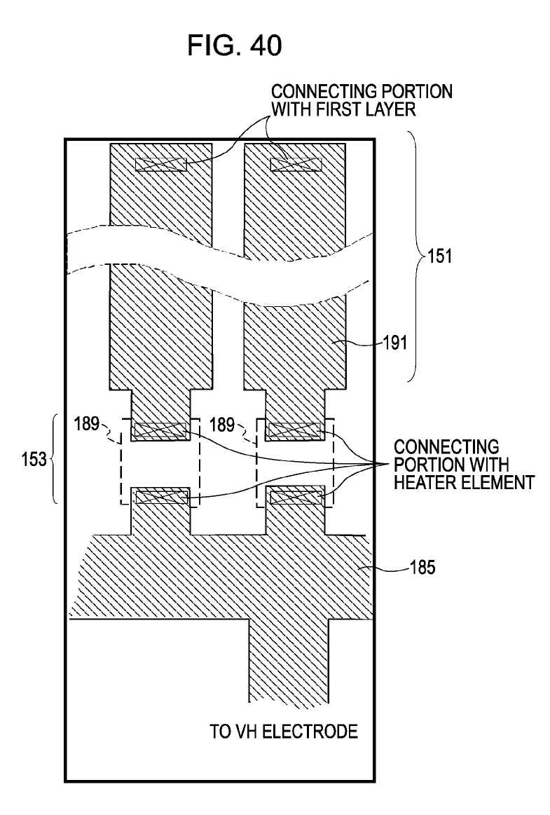

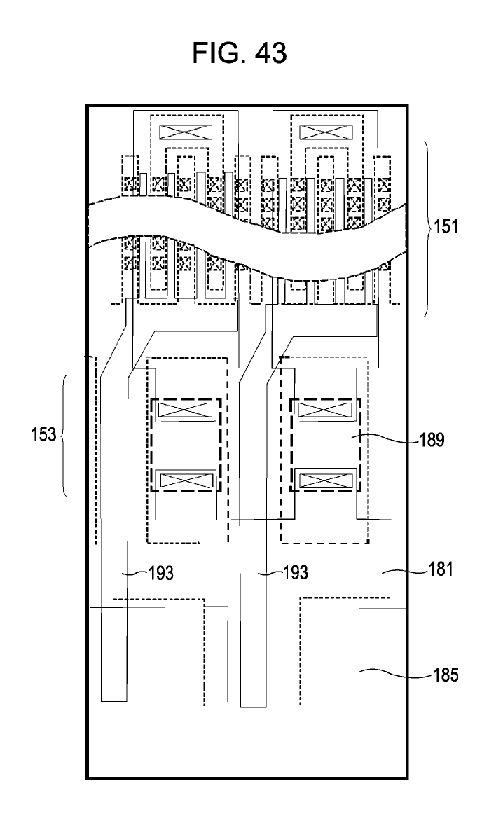

Note that the structure shown in each of FIGS. 40 to 43 is adopted for the actual wiring pattern. Of these, FIGS. 40 to 42 show an example of the wiring pattern for each layer corresponding to FIG. 38. FIG. 43 is a view, as seen from the surface side of the chip element, of the wiring patterns for respective layers shown in FIGS. 40 to 42 in an overlapped state.

FIG. 40 shows an example of the wiring pattern for the second layer (upper level layer). FIG. 40 shows the portion in the vicinity of the heater portion 153. The wiring pattern 185, which is one used for supplying the power source potential (VH), is connected to one terminal of each of heater elements 189. Further, the other end of each heater element 189 is connected to each wiring pattern 191 connected to a wiring (drain terminal of the transistor) of the first layer.

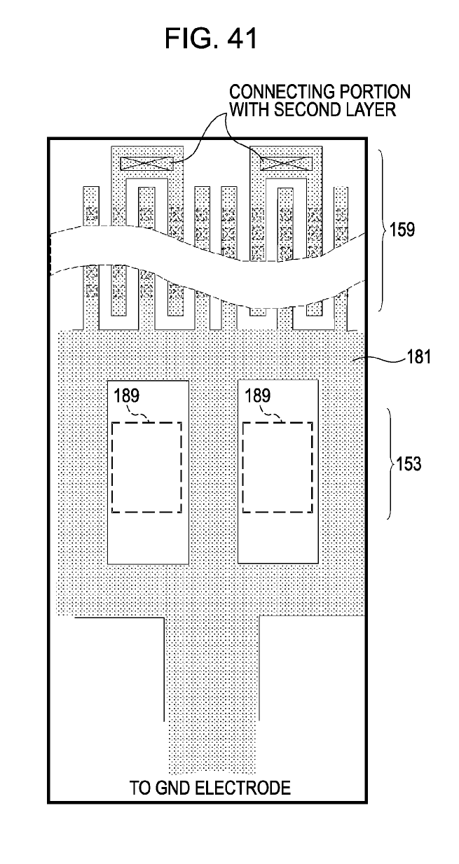

FIG. 41 shows an example of the wiring pattern for the first layer (lower level layer). FIG. 41 also shows the portion in the vicinity of the heater portion 153. The wiring pattern 181, which is one used for supplying the ground potential (GND), is connected to a source terminal of the transistor while passing through the region between adjacent heater elements 189. Note that the drain terminal of the transistor is connected to the wiring pattern 191 of the second layer.

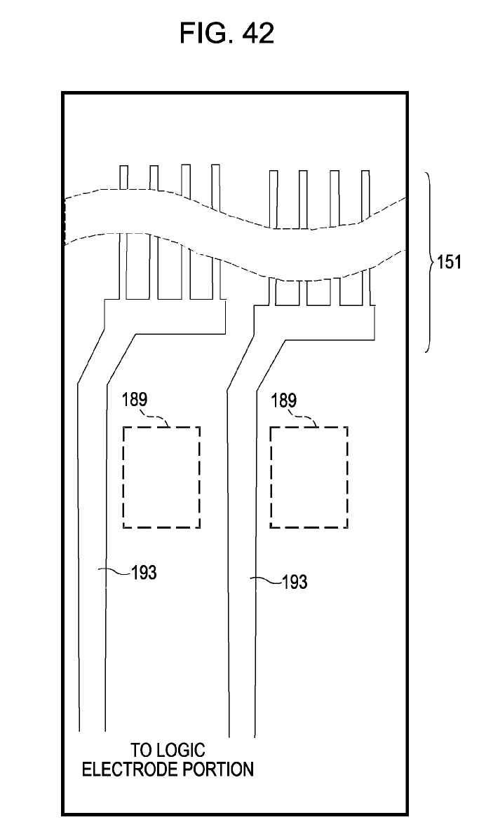

FIG. 42 shows control wiring patterns 193 for controlling the operations of transistors serving as the driver elements. The end portion of each wiring pattern 193 on the driver transistor portion 153 side is connected to a gate terminal of the transistor. On the other hand, the opposite end portion of the wiring pattern is connected to a terminal of the logic circuit portion 155.

The wiring pattern 193 is also arranged so as to pass through the region between adjacent heater elements 189. In the case of this arrangement, the control wiring pattern 193 is arranged in a layer lower than the wiring pattern 181 for the ground electrode (GND).

Note that the terms “the first layer” and “the second layer” as mentioned above are used for the purpose of illustrating the layering relationship between the wiring pattern for the ground potential (GND) and the wiring pattern for the power source potential (VH).

FIG. 43 shows the positional relation in the case where the wiring patterns of all the layers are overlapped together.

### (D) EFFECT OF EMBODIMENT EXAMPLE

The chip element can be miniaturized by arranging the driver transistor portion 151, the heater portion 153, and the logic circuit portion 155 in this order in the direction of the short side (direction orthogonal to the alignment direction of the heater elements) of the chip element from the common-passage-side end portion of the chip element. That is, the driver portion 151 arranged at the end portion of the chip element can be used as the bonding region between the top plate 141 and the coating layer 127, thereby making it possible to increase the number of chip elements that can be cut out from one semiconductor substrate. It is thus possible to achieve a reduction in manufacturing cost.

Further, when the wiring pattern for the power source potential (VH) and the wiring pattern for the ground potential (GND) are arranged within the same plane, the chip element can be realized by means of a simple wiring pattern. At this time, when two or more electrodes are connected to each of the wiring patterns for the respective potentials, the energy that can be supplied to the heater elements can be increased, thereby making it possible to achieve improvements in printing speed and discharge performance.

Further, when the wiring pattern for the power source potential (VH) and the wiring pattern for the ground potential (GND) are arranged separately in two layers, the two wiring patterns can be arranged along the outer longitudinal edge of the heater portion 153.

In this case, the supply of a potential to the heater element or drain terminal can be realized through the shortest path. Accordingly, the amount of energy that can be supplied to the heater element can be increased as compared with that in the one-layer type arrangement, thereby making it possible to achieve an improvement in printing speed and discharge performance.

Further, when the wiring pattern is split in two layers, it is not necessary to arrange the wiring pattern for the ground electrode (GND) in the outer edge of the chip element, thereby achieving a further reduction in the size of the chip element. That is, it is possible to achieve a reduction in manufacturing cost.

### (E) OTHER EMBODIMENT EXAMPLES

(a) In the above-described embodiment examples, the description is directed to the chip element of a drive system in which one heater element is arranged with respect to one nozzle.

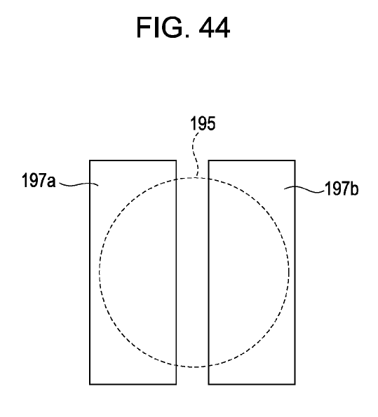

However, the present invention is also applicable to a chip element that adopts a drive system in which, as shown in FIG. 44, two heater elements 197a and 197b are arranged with respect to one nozzle 195. Here, the pair of heater elements 197a and 197b are arranged along the alignment direction of the heater elements (longitudinal direction of the chip element). In the case of the chip element having this heater element structure, the discharge direction of ink droplets can be deflected by making the energies (voltages) applied to the two left and right heater elements 197a and 197b asymmetrical.

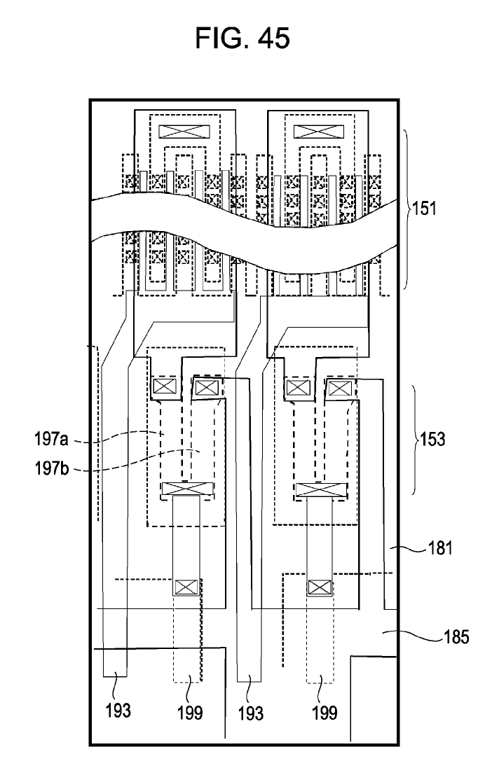

FIG. 45 is a view, as seen from the surface side of the chip element, of wiring patterns in the case where the wiring pattern for the power source potential (VH) and the wiring pattern for the ground potential (GND) are arranged separately in two layers. The heater elements 197a and 197b are connected in series. Note that the two heater elements 197a and 197b are arranged in parallel within the same plane.

In FIG. 45, there is adopted a mechanism whereby the energy applied to each of the heater elements 197a and 197b can be adjusted by adjusting the potential at the connection midpoint between the heater element 197a and the heater element 197b. In the drawing, the shaded wiring pattern 199 is the wiring for imparting the potential of the connection midpoint. One end of the wiring pattern 199 is connected to the electrode of the electrode portion 157.

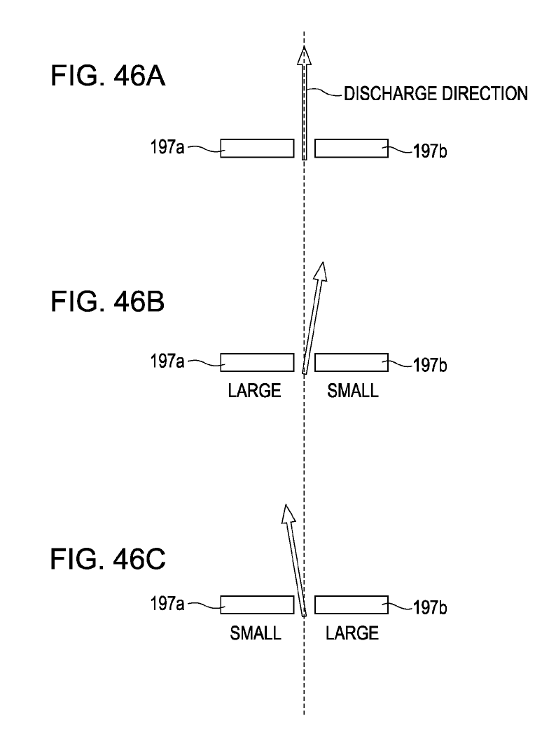

FIGS. 46A to 46C show the relationship between the way the connection midpoint potential is imparted and the discharge direction of an ink droplet.

FIG. 46A shows an example of discharge in which the connection midpoint potential is set to be the half of the driving potential (VH). In this case, the same magnitude of energy is applied to the heater elements 197a and 197b. At this time, the heater elements exhibit the same heating characteristics, so the ink droplet is discharged straight ahead.

FIG. 46B shows an example of discharge in which the connection midpoint potential is set to be larger than the half of the driving potential (VH). In this case, the energy applied to the heater element 197a becomes larger than the energy applied to the heater element 197b. At this time, the heater element 197a exerts a larger ink droplet discharging force relative to the heater element 197b, so the ink droplet is discharged while being deflected in the rightward direction (the heater element 197b side) with respect to the straight-ahead direction.

FIG. 46C shows an example of discharge in which the connection midpoint potential is set to be smaller than the half of the driving potential (VH). In this case, the energy applied to the heater element 197b becomes larger than the energy applied to the heater element 197a. At this time, the heater element 197b exerts a larger ink droplet discharging force relative to the heater element 197a, so the ink droplet is discharged while being deflected in the leftward direction (the heater element 197a side) with respect to the straight-ahead direction.

As described above, the above-described technique can be also applied to chip elements having the function of deflected discharge.

(b) In the above-described embodiment examples, the description is directed to the case where the liquid to be discharged is ink. However, the kind of liquid is not limited to ink. When the present invention is applied to a display device or an electronic circuit manufacturing device, for example, an organic or electrically conductive material may be used.

(c) The above-described embodiment examples may be subject to various modifications within the scope of the present invention. Further, various modifications or applications may be created on the basis of the description of this specification.

What is claimed is:

1. A liquid discharge head comprising:
a plurality of energy generating elements arranged in one direction on a substrate;
a coating layer formed on the substrate and having formed therein a plurality of discharge ports opposed to the energy generating elements; and
an individual passage formed on the substrate and extending in a direction orthogonal to a direction in which the energy generating elements are arranged,
the liquid discharge head being adapted to discharge a liquid, which is supplied to the individual passage, from each of the discharge ports by the energy generating elements,
wherein the coating layer on the individual passage has an opening formed therein.

2. The liquid discharge head according to claim 1, wherein the opening is not larger in size than the discharge ports.

3. A liquid discharge head comprising:
a plurality of energy generating elements arranged in one direction on a substrate;
a coating layer formed on the substrate and having formed therein a plurality of discharge ports opposed to the energy generating elements;
an individual passage formed on the substrate and extending in a direction orthogonal to a direction in which the energy generating elements are arranged; and
a liquid supply member which has a common passage formed therein and to which the substrate is bonded so that the common passage and the individual passage communicate with each other, the common passage being penetrated through a base of the liquid supply member,
the liquid discharge head being adapted to discharge a liquid, which is supplied from the common passage to the individual passage, from each of the discharge ports by the energy generating elements,
wherein:
the coating layer on the individual passage has an opening formed therein; and
the liquid discharge head includes a top plate attached to the coating layer on the individual passage, the top plate straddling and sealing a portion of the liquid supply member penetrated for forming the common passage.

4. The liquid discharge head according to claim 3, wherein the opening is closed by the top plate.

5. A liquid discharge head manufacturing method, comprising:
a first step of forming a sacrificial layer on a substrate, on which a plurality of energy generating elements for discharging a liquid are arranged in one direction, from a soluble resin;
a second step of forming a coating layer on the sacrificial layer;
a third step of forming in the coating layer a plurality of discharge ports opposed to the energy generating elements, the third step being performed simultaneously with or after the second step;
a fourth step of forming an individual passage by eluting the sacrificial layer, the individual passage extending in a direction orthogonal to a direction in which the energy generating elements are arranged; and
an opening forming step of forming an opening in the coating layer on the individual passage, the opening forming step being performed simultaneously with or before or after the third step.

6. The liquid discharge head manufacturing method according to claim 5, further comprising a cutting opening forming step of forming a cutting opening in a portion of the coating layer on a side opposite to the discharge ports across the individual passage, the cutting opening forming step being performed simultaneously with or before or after the third step.

7. The liquid discharge head manufacturing method according to claim 6, wherein the opening is formed at the middle between each of the discharge ports and the cutting opening.

8. The liquid discharge head manufacturing method according to claim 6, further comprising a cutting step of cutting the substrate along the cutting opening, the cutting step being performed after the fourth step.

9. A liquid discharge head manufacturing method, comprising:
a first step of forming a sacrificial layer on a substrate, on which a plurality of energy generating elements for discharging a liquid are arranged in one direction, from a soluble resin;
a second step of forming a coating layer on the sacrificial layer;
a third step of forming in the coating layer a plurality of discharge ports opposed to the energy generating elements, the third step being performed simultaneously with or after the second step;
a fourth step of forming an individual passage by eluting the sacrificial layer, the individual passage extending in a direction orthogonal to a direction in which the energy generating elements are arranged;
a fifth step of bonding the substrate onto a liquid supply member having a common passage formed therein so that the common passage and the individual passage communicate with each other, the common passage being penetrated through a base of the liquid supply member;
an opening forming step of forming an opening in the coating layer on the individual passage, the opening forming step being performed simultaneously with or before or after the third step; and
a sealing step of attaching a top plate onto the coating layer on the individual passage, the top plate straddling and sealing a portion of the liquid supply member penetrated for forming the common passage, the sealing step being performed after the fifth step.

10. The liquid discharge head manufacturing method according to claim 9, wherein the sealing step includes sealing the portion of the liquid supply member penetrated for forming the common passage and closing the opening.

11. A liquid discharge head comprising:
a plurality of energy generating elements arranged in one direction on a substrate;
an individual passage formed on the substrate and extending in a direction orthogonal to a direction in which the energy generating elements are arranged; and
a coating layer covering the individual passage and having formed therein a plurality of discharge ports opposed to the energy generating elements,
the liquid discharge head being adapted to discharge a liquid, which is supplied to the individual passage, from each of the discharge ports by the energy generating elements,
wherein the coating layer has a recessed portion formed in a portion of the coating layer on a side opposite to the discharge ports across the individual passage, the recessed portion being recessed toward the individual passage.

12. The liquid discharge head according to claim 11, wherein the recessed portion of the coating layer is formed in a shape of a triangular or semi-circular recess.

13. A liquid discharge head comprising:
a plurality of energy generating elements arranged in one direction on a substrate;
an individual passage formed on the substrate and extending in a direction orthogonal to a direction in which the energy generating elements are arranged,
a coating layer covering the individual passage and having formed therein a plurality of discharge ports opposed to the energy generating elements;
a liquid supply member which has a common passage formed therein and to which the substrate is bonded so that the common passage and the individual passage communicate with each other, the common passage being penetrated through a base of the liquid supply member,
the liquid discharge head being adapted to discharge a liquid, which is supplied from the common passage to the individual passage, from each of the discharge ports by the energy generating elements,
wherein:
the coating layer has a recessed portion formed in a portion of the coating layer on a side opposite to the discharge ports across the individual passage, the recessed portion being recessed toward the individual passage; and
the liquid discharge head includes a top plate attached onto the coating layer on the individual passage, the top plate closing the recessed portion of the coating layer and straddling and sealing a portion of the liquid supply member penetrated for forming the common passage.

14. The liquid discharge head according to claim 13, wherein the deepest part of the recessed portion of the coating layer is recessed within a range of 5 to 20% of a length of a portion closed by the top plate.

15. A liquid discharge head manufacturing method, comprising:
a first step of forming a sacrificial layer on a substrate, on which a plurality of energy generating elements for discharging a liquid are arranged in one direction, from a soluble resin;
a second step of forming a coating layer on the sacrificial layer;
a third step of forming in the coating layer a plurality of discharge ports opposed to the energy generating elements, the third step being performed simultaneously with or after the second step;
a fourth step of forming an individual passage by eluting the sacrificial layer, the individual passage extending in a direction orthogonal to a direction in which the energy generating elements are arranged;
an opening forming step of forming an opening in the coating layer so that the coating layer has a recessed portion, which is recessed toward the individual passage, formed in a portion of the coating layer on a side opposite to the discharge ports across the individual passage, the opening forming step being performed simultaneously with or before or after the third step; and
a cutting step of cutting the substrate inside the opening.

16. The liquid discharge head manufacturing method according to claim 15, wherein the recessed portion of the coating layer is formed in a shape of a triangular or semi-circular recess.

17. A liquid discharge head manufacturing method, comprising:
a first step of forming a sacrificial layer on a substrate, on which a plurality of energy generating elements for discharging a liquid are arranged in one direction, from a soluble resin;
a second step of forming a coating layer on the sacrificial layer;
a third step of forming in the coating layer a plurality of discharge ports opposed to the energy generating elements, the third step being performed simultaneously with or after the second step;
a fourth step of forming an individual passage by eluting the sacrificial layer, the individual passage extending in a direction orthogonal to a direction in which the energy generating elements are arranged; and
a fifth step of bonding the substrate onto a liquid supply member having a common passage formed therein so that the common passage and the individual passage communicate with each other, the common passage being penetrated through a base of the liquid supply member;
an opening forming step of forming an opening in the coating layer so that the coating layer has a recessed portion, which is recessed toward the individual passage, formed in a portion of the coating layer on a side opposite to the discharge ports across the individual passage, the opening forming step being performed simultaneously with or before or after the third step; and
a sealing step of attaching a top plate onto the coating layer on the individual passage, the top plate closing the recessed portion and straddling and sealing a portion of the liquid supply member penetrated for forming the common passage, the sealing step being performed after the fifth step.

18. The liquid discharge head manufacturing method according to claim 17, wherein the sealing step includes attaching the top plate onto the coating layer so that the deepest part of the recessed portion of the coating layer is recessed within a range of 5 to 20% of a length of a portion closed by the top plate.

19. A chip element having circuit elements for discharging ink droplets integrated into a semiconductor layer, comprising:
a circuit pattern having a driver element region, a heater element region, and a control circuit region arranged in this order from a side surface end portion of the chip element which is in contact with the common passage for the liquid, toward a side where an ink chamber is arranged.

20. The chip element according to claim 19, further comprising a wiring pattern for a power source potential and a wiring pattern for a ground electrode that are arranged at the same layer level.

21. The chip element according to claim 19, further comprising a wiring pattern for a power source potential and a wiring pattern for a ground electrode that are arranged at different layer levels.

22. A liquid discharge head for discharging an ink droplet by heating a liquid in a liquid chamber, comprising:
a common passage for the liquid, the common passage being formed in a base;
a chip element having a driver element region, a heater element region, and a control circuit region arranged in this order from its side surface end portion in contact with the common passage toward a side where the ink chamber is arranged; and
a sealing member for sealing an opening of the common passage, which is exposed on an upper surface of the base, integrally with a part of a surface of the chip element.

23. A printing apparatus comprising a liquid discharge head for discharging an ink droplet by heating a liquid in a liquid chamber, and a driver mechanism for moving a recording medium and the liquid discharge head relative to each other,
wherein the liquid discharge head includes:
a common passage for the liquid, the common passage being formed in a base;
a chip element having a driver element region, a heater element region, and a control circuit region arranged in this order from its side surface end portion in contact with the common passage toward a side where the ink chamber is arranged; and
a sealing member for sealing an opening of the common passage, which is exposed on an upper surface of the base, integrally with a part of a surface of the chip element.
